(19) United States
(12) Patent Application Publication
(10) Pub. No.: US 2008/0259230 A1
(43) Pub. Date: Oct. 23, 2008

(54) Polarizing sheet and production method thereof

(75) Inventors: Hakaru Miyakita, Kawabe-gun (JP); Yumiko Hashimoto, Osaka (JP); Yingxin He, Osaka (JP); Atsushi Kanazawa, Osaka (JP); Takashi Fujii, Osaka (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/882,885

(22) Filed: Aug. 6, 2007

(30) Foreign Application Priority Data
Aug. 8, 2006 (JP) 2006-215474
Aug. 11, 2006 (JP) 2006-219482
Dec. 1, 2006 (JP) 2006-325335
Mar. 29, 2007 (JP) 2007-087295

(51) Int. Cl. G02B 1/08; B29D 11/00; G02F 1/1335

(52) U.S. Cl. 349/8; 428/409; 264/1.34

(57) ABSTRACT

A polarizing sheet having a transparent substrate on both surfaces of a polarizing film containing a polarizer, wherein exposed portions of the polarizing film not covered by the transparent substrate are covered with a sealing material.

### BACKGROUND OF THE INVENTION

1. Technical Field

The present invention relates to a polarizing sheet and a method for producing the same.

2. Description of Related Art

For meeting increase in screen size, projection type liquid crystal displays are spreading rapidly for institutional and household uses, instead of conventional cathode ray tube type displays.

The projection type is a system in which light from a light source is separated into RGB three primary colors, then, respective lights pass through a liquid crystal panel, polarizing sheet and the like along respective light paths, and finally, are enlarged by a projection lens, to form on a screen an image to be displayed. As the projection type liquid crystal display, a front projector by which an image is projected to a screen from the side of observers is used mainly for institutional use, and a rear projector by which an image is projected toward observers from the rear side of a screen is used mainly for household use.

Recently, in projection type liquid crystal displays, rising of brilliance of a screen is progressing, thereby, a high pressure mercury lamp discharging strong light has come to be used. Thus, a property by which a polarizing sheet disposed in a light path can be used for a long period of time against the strong light and heat, namely, light resistance, has come to be required, accordingly, the light resistance of the polarizing sheet has become so important factor as to determine the life of a projection type liquid crystal display.

Recently, it is reported that a polarizing sheet manufactured by joining a polarizing film containing a polarizer and a protective film to a transparent substrate made of a material of high thermal conductivity allows heat generated from the polarizing film to be discharged from the transparent substrate, to lower the temperature of the polarizing film, thereby improving the light resistance of the polarizing sheet, and there are suggested, for example, a polarizing sheet using a transparent substrate made of sapphire glass of high thermal conductivity (Patent Document 1: JP-A No. 2000-206507 ([Claim 1], [0029]) and a polarizing sheet using a YAG substrate of high thermal conductivity as a transparent substrate (Patent Document 2: JP-A No. 2002-55231 ([Claim 1], [0005]).

Patent Document 3 (JP-A No. 10-39138 ([Claim 1], [0004]) suggests a constitution in which transparent substrates sandwich directly a polarizer without using a protective film, for allowing heat generated in the polarizer to conduct directly to the transparent substrate.

There is a tendency of further increase in light quantity of projectors for the demand of rising of brilliance of a screen, and it has become apparent that the substrate improvements disclosed in Patent Documents 1 and 2 cannot secure sufficient light resistance.

There is also a problem that sufficient light resistance cannot be secured even by the method of Patent Document 3.

### SUMMARY OF THE INVENTION

The present invention provides a polarizing sheet having light resistance remarkably excellent as compared with conventional sheets and a method for producing the same, solving the problems as described above.

The present inventors have investigated to attain further improvement in light resistance, and resultantly found that, in a polarizing sheet having a transparent substrate on both surfaces of a polarizing film, light resistance can be improved by sealing exposed portions of the polarizing film not covered by the transparent substrate.

That is, the present invention provides the following [1] to [30].

[1]. A polarizing sheet having a transparent substrate on both surfaces of a polarizing film containing a polarizer, wherein exposed portions of the polarizing film not covered by the transparent substrate are covered with a sealing material.

[2]. The polarizing sheet according to [1], wherein the water content of the polarizer is 5 wt % or less.

[3]. The polarizing sheet according to [1], wherein the sealing material is an ultraviolet ray-hardening adhesive or a thermosetting adhesive.

[4]. The polarizing sheet according to [3], wherein the sealing material has a glass transition temperature after hardening of 80° C. or higher.

[5]. The polarizing sheet according to [3], wherein the sealing material has a viscosity at 25° C. before hardening of 10 Pa·s or less.

[6]. The polarizing sheet according to [1], wherein the sealing material has a boiling water absorption coefficient after hardening of 4 wt % or less.

[7]. The polarizing sheet according to [1], wherein the sealing material has a boiling water absorption coefficient after hardening of 2 wt % or less.

[8]. The polarizing sheet according to [1], wherein at least one of the transparent substrates is made of a material having a thermal conductivity coefficient of 5 W/mK or more.

[9]. The polarizing sheet according to [1], wherein resin layers are formed between the transparent substrate made of a material having a thermal conductivity coefficient of 5 W/mK or more and the polarizer, and the total thickness of the resin layers is 0.1 μm or more and less than 10 μm.

[10]. The polarizing sheet according to [9], wherein the material of one of the transparent substrates is quartz crystal or sapphire, and the material of the other substrate is quartz crystal, quartz glass, silicate glass or borosilicate glass.

[11]. The polarizing sheet according to [1], wherein the polarizing film is a polarizing film containing a polarizer and a protective film.

[12]. The polarizing sheet according to [11], wherein the polarizing film has a water content of 1.6 wt % or less.

[13]. The polarizing sheet according to [11], wherein the protective film has a thickness of 10 to 45 μm.

[14]. The polarizing sheet according to [11], wherein the protective film is a film containing triacetylcellulose or an olefin resin film.

[15]. The polarizing sheet according to [11], wherein at least one of the transparent substrates is made of a material having a thermal conductivity coefficient of 5 W/mK or more.

[16]. The polarizing sheet according to [11], wherein resin layers are formed between the transparent substrate made of a material having a thermal conductivity coefficient of 5 W/mK or more and the polarizer, and the total thickness of the resin layers is 0.1 μm or more and less than 10 μm.

[17]. The polarizing sheet according to [16], wherein the material of one of the transparent substrates is quartz crystal or sapphire, and the material of the other substrate is quartz crystal, quartz glass, silicate glass or borosilicate glass.

[18]. The polarizing sheet according to [11], wherein the polarizing film is composed of one polarizer and one protective film, a transparent substrate is pasted to both surfaces of the polarizing film, and the transparent substrate pasted to the polarizer is a transparent substrate made of a material having no optical anisotropy.

[19]. The polarizing sheet according to [18], wherein the transparent substrate having no optical anisotropy is made of silicate glass or borosilicate glass.

[20]. The polarizing sheet according to [1], wherein the sheet has a lamination part having a thickness of 1 μm or more and 30 μm or less between the polarizer and at least one of the transparent substrates, the lamination part is composed of two or more resin layers formed from a thermosetting resin or an ultraviolet-hardening resin, and the lamination part contains an adhesive layer.

[21]. The polarizing sheet according to [20], wherein the content of volatile components of the resin layers formed in the polarizing sheet before hardening is 2 wt % or less.

[22]. The polarizing sheet according to [20], wherein the viscosity of the resin layer formed in the polarizing sheet before hardening is 0.01 Pa·s or more and 20 Pa·s or less at 25° C.

[23]. The polarizing sheet according to [20], wherein when the resin layer formed in the polarizing sheet has a thickness after hardening of 25 μm, light transmittance is 90% or more in the wavelength range of 400 nm to 700 nm.

[24]. A method for producing a polarizing sheet having a transparent substrate on both surfaces of a polarizing film containing a polarizer and in which exposed portions of the polarizing film not covered with the transparent substrate are covered with a sealing material, wherein the transparent substrate is adhered using a resin to both surfaces of the polarizing film, the polarizing film is dried, thereafter, exposed portions of the polarizing film not covered with the transparent substrate are covered with a sealing material.

[25]. The method for producing a polarizing sheet according to [24], wherein, in adhering the transparent substrate using a resin to the polarizing film, at least one of a process for forming a resin layer before hardening the resin to be used as an adhesive layer and a process for setting an article to be adhered is carried out under reduced pressure.

[26]. The method for producing a polarizing sheet according to [24], wherein the method contains a process of drying the polarizing film at temperatures of 110° C. or lower, before adhering the second transparent substrate to the polarizing film.

[27]. The method for producing a polarizing sheet according to [24], wherein at least one of the transparent substrates has a concave defective part and/or hole part for sealing material injection, and the method contains a process for injecting a sealing material through the concave defective part and/or hole part.

[28]. A projection type liquid crystal display having the polarizing sheet according to [1].

[29]. The polarizing sheet according to [1], wherein when the resin covering exposed portions of the polarizer has a film thickness after hardening of 100 μm, the water vapor transmission rate under environments of a temperature of 40° C. and a relative humidity of 90% is 60 g/m²·24 hr or less.

[30]. The polarizing sheet according to [1], wherein when the resin covering exposed portions of the polarizer has a film thickness after hardening of 100 μm, the water vapor transmission rate under environments of a temperature of 40° C. and a relative humidity of 90% is 25 g/m²·24 hr or less.

### BRIEF EXPLANATION OF DRAWINGS

FIG. 1 is a view illustrating the constitution of a polarizing sheet of the present invention (constitutional view of Example 1).

FIG. 2 is a view illustrating the constitution of a polarizing sheet of the present invention (constitutional view of Example 3).

FIG. 3 is a view illustrating the constitution of a polarizing sheet of the present invention.

FIG. 4 is a view illustrating the constitution of a polarizing sheet of the present invention.

FIG. 5 is a view illustrating the constitution of a polarizing sheet of the present invention (constitutional view for Examples 2 and 4).

FIG. 6 is a view illustrating the constitution of a polarizing sheet of the present invention.

FIG. 7 is a view illustrating the constitution of a polarizing sheet used in Comparative Example 1 (constitutional view for Comparative Example 1).

FIG. 8 is a view illustrating the constitution of a polarizing sheet used in Comparative Example 2 (constitutional view for Comparative Example 2).

FIG. 9 is a view illustrating the constitution of a polarizing sheet of the present invention (constitutional view for Example 5).

FIG. 10 is a view illustrating the constitution of a polarizing sheet of the present invention.

FIG. 11 is a view illustrating the constitution of a polarizing sheet of the present invention (constitutional view for Example 6).

FIG. 12 is a view illustrating the constitution of a polarizing sheet of the present invention.

FIG. 13 is a view illustrating the constitution of a polarizing sheet of the present invention (constitutional view for Example 7).

FIG. 14 is a view illustrating the constitution of a polarizing sheet of a comparative example.

FIG. 15 is a view illustrating the constitution of a polarizing sheet of the present invention (constitutional view for Example 12).

FIG. 16 is a view illustrating the constitution of a polarizing sheet of the present invention.

FIG. 17 is a view illustrating the constitution of a polarizing sheet of the present invention (constitutional view for Examples 13 and 14).

FIG. 18 is a view illustrating the constitution of a polarizing sheet of the present invention.

FIG. 19 is a view illustrating the constitution of a polarizing sheet of a comparative example (constitutional view for Comparative Example 5).

FIG. 20 is a view illustrating the constitution of a polarizing sheet of a comparative example (constitutional view for Comparative Example 6).

FIG. 21 shows a transparent substrate used in Example 9.

FIG. 22 is an assembly view of a polarizing sheet of Example 9.

FIG. 23 shows a transparent substrate used in Example 10.

FIG. 24 is an assembly view of a polarizing sheet of Example 8.

FIG. 25 is a view of projector light paths.

FIG. 26 shows a light resistance evaluation apparatus.

FIG. 27 is a view illustrating the constitution of a polarizing sheet of the present invention (constitutional view for Example 15).

### DESCRIPTION OF MARKS

(1) transparent substrate (transparent substrate (A) in FIGS. 1 to 6)
(2) transparent substrate (transparent substrate (B) in FIGS. 1 to 6)
(3) protective film
(4) polarizer
(5) sealing material
(6) part of exposure of polarizing film in the case of no sealing material
(7) spacer
(8) concave defective part
(9) hole part
(10) syringe
(11) sealing material (unhardened)
(12) flow of sealing material (unhardened)
(14) resin layer (a)
(15) resin layer (b)
(16) resin layer (c)
(20) high pressure mercury lamp
(21) UV/IR cut filter
(22) flyeye lens
(23) polarizing beam splitter array
(24) dichroic mirror
(25) lens
(26) sample holder
(27) white light
(28) red, green light
(29) blue light
(111) high pressure mercury lamp
(112) lens array
(112a) minute lens
(113) lens array
(114) polarizing light converting device
(115) superimposed lens
(122) reflection mirror
(121) dichroic mirror
(123) dichroic mirror
(132) dichroic mirror
(134) reflection mirror
(135) lens
(140R) LCD panel for red
(140G) LCD panel for green
(140B) LCD panel for blue
(142) polarizing sheet (incident side)
(143) polarizing sheet (outgoing side)
(150) cross dichroic prism
(170) projection lens
(180) screen

### DETAILED DESCRIPTIONS OF PREFERRED EMBODIMENTS

Conventionally, as a method for improving the light resistance of a polarizing sheet for projector, application of a sapphire substrate of excellent thermal conductivity coefficient and application of glass on both surfaces have been tried. However, a polarizing sheet in which a sapphire substrate is used as one transparent substrate and a polarizing film is sandwiched on its both surfaces by transparent substrates, devised from a combination of the above-described technologies, leads to no significant improvement in light resistance. That is, the present inventors have found that weakness of light resistance of a polarizer is attributable to trace amount of water remaining in the polarizer (usually, using PVA). In an embodiment of sandwiching a polarizing film on its both surfaces by transparent substrates, an end surface of the polarizing film containing a polarizer not covered by the transparent substrate is, for suppressing deterioration of the polarizer, covered by a sealing material to prevent invasion of moisture in air, thereby, significant improvement in light resistance has been attained.

Namely, the preferable polarizing sheet is a polarizing sheet having a transparent substrate on both surfaces of a polarizing film containing a polarizer in which exposed portions of the polarizing film not covered by the transparent substrate are covered with a sealing material.

The constitution of a polarizing sheet of the present invention will be illustrated in detail using drawings.

FIGS. 1 to 6, 9 to 13, and 15 to 18 show the structures of a polarizing sheet of the present invention, however, the present invention is not limited to polarizing sheets having these structures.

First, a polarizing sheet having no protective film will be illustrated.

FIG. 1 explains the structure of a polarizing sheet of the present invention. A polarizer is connected via a resin layer (a) to a transparent substrate (A) having a thermal conductivity of 5 W/mK or more, and two layers of resin layers (b) and (c) are formed between another transparent substrate (B) and the polarizer. An end surface (side surface) of the polarizer and, end surfaces of the resin layers (a), (b) and (c) are covered with a sealing material.

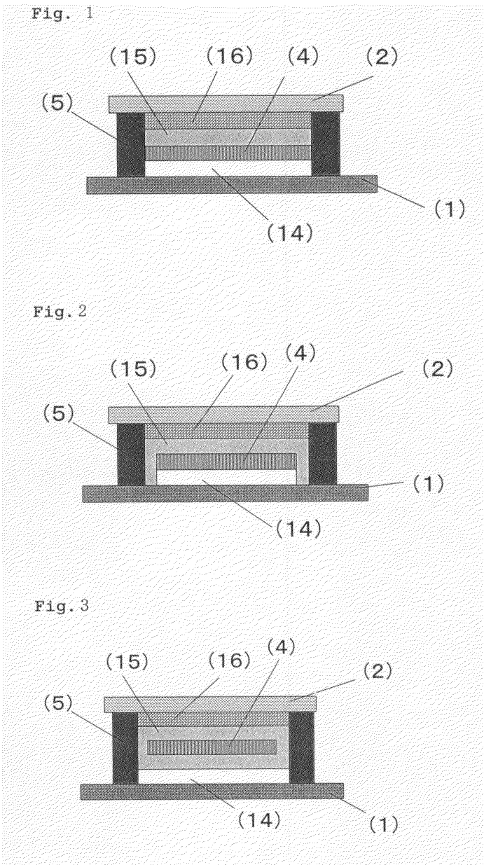

As shown in FIG. 2, it may be permissible that a polarizer is connected via a resin layer (a) to a transparent substrate (A) having a thermal conductivity of 5 W/mK or more, and two layers of resin layers (b) and (c) are formed between another transparent substrate (B) and the polarizer, and an end surface of the polarizer is covered with a resin layer (b) and end surfaces of the resin layers (b) and (c) are covered with a sealing material.

As shown in FIG. 3, it may be permissible that two layers of resin layers (a) and (b) are formed between a polarizer and a transparent substrate (A) having a thermal conductivity of 5 W/mK or more, two layers of resin layers (b) and (c) are formed between the polarizer and another transparent substrate (B), an end surface of the polarizer is covered with the resin layer (b), and end surfaces of the resin layers (a), (b) and (c) are covered with a sealing material.

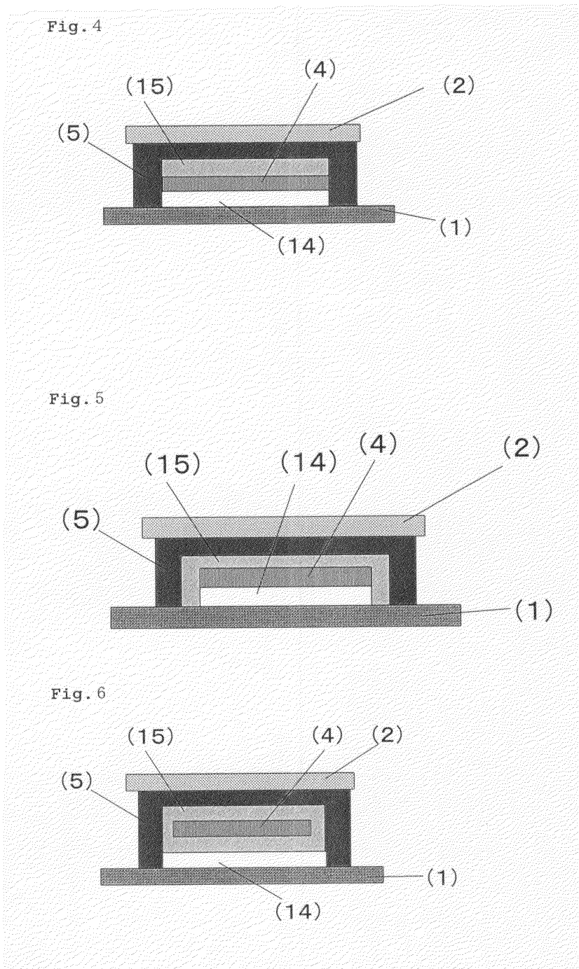

As shown in FIG. 4, it may be permissible that a polarizer is connected via a resin layer (a) to a transparent substrate (A) having a thermal conductivity of 5 W/mK or more, two layers of a resin layer (b) and a sealing material are formed between another transparent substrate (B) and the polarizer, and an end surface of the polarizer and end surfaces of the resin layers (a) and (b) are covered with a sealing material.

As shown in FIG. 5, it may be permissible that a polarizer is connected via a resin layer (a) to a transparent substrate (A) having a thermal conductivity of 5 W/mK or more, two layers of a resin layer (b) and a sealing material are formed between another transparent substrate (B) and the polarizer, end surfaces of the polarizer and the resin layer (a) are covered with the resin layer (b), and an end surface of the resin layer (b) is covered with a sealing material.

As shown in FIG. 6, it may be permissible that two layers of resin layers (a) and (b) are formed between a polarizer and a transparent substrate (A) having a thermal conductivity of 5 W/mK or more, two layers of the resin layer (b) and a sealing material are formed between the polarizer and another transparent substrate (B), and end surface of the polarizer is covered with the resin layer (b) and end surfaces of the resin layers (a) and (b) are covered with a sealing material.

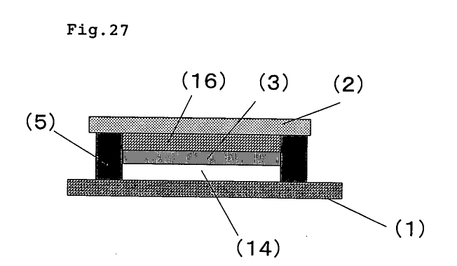

As shown in FIG. 27, it may be permissible that a resin layer (a) is formed between a polarizer and a transparent substrate (A) having a thermal conductivity of 5 W/mK or more, a resin layer (c) is formed between the polarizer and another transparent substrate (B), and an end surface of the polarizer is covered with a sealing material.

More preferred is a polarizing sheet in which resin layers are formed between a transparent substrate made of a material having a thermal conductivity coefficient of 5 W/mK or more and a polarizer, and the total thickness of the resin layers is 0.1 μm or more and less than 10 μm.

Next, a polarizing sheet having a protective film will be illustrated.

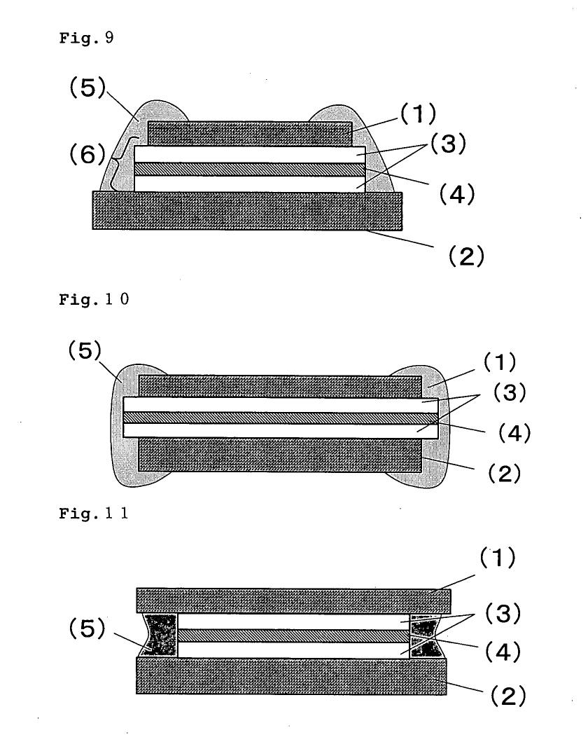

In FIGS. 9 to 13, and 15 to 18, though resin layers for performing adhesion between a transparent substrate and a polarizer, between a transparent substrate and a protective film, between a polarizer and a protective film, between a spacer and a transparent substrate, and the like, are not shown, resin layers are present between respective constituent elements.

In the case of the constitution shown in FIG. 9, namely, if a polarizing film is smaller than a transparent substrate (2) and a transparent substrate (1) is smaller than the polarizing film, then, portions of the polarizing film contacting air, specifically, the cross-section of a polarizing sheet and exposed portions (6) thereof not covered by the transparent substrate (1) are covered with an organic and/or inorganic sealing material (5) for blocking contact with air. The sealing material is formed on outer peripheral regions of the polarizing sheet, and when the polarizing sheet is, for example, quadrangle, the sealing material covers all of the four sides.

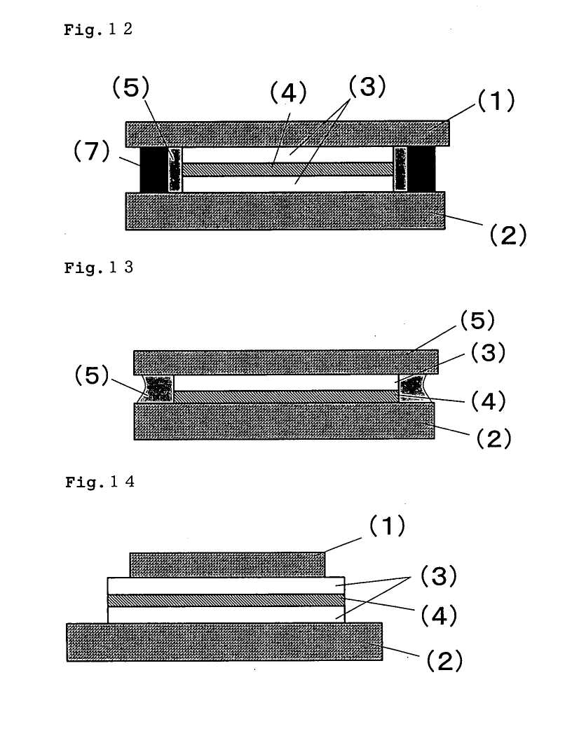

When a polarizing film is larger than transparent substrates (1) and (2) as shown in FIG. 10, it is necessary that exposed portions are, including parts of the transparent substrates, covered with a sealing material. When a polarizing film is smaller than transparent substrates (1) and (2) as shown in FIG. 3, the same effect is obtained by covering only the cross-section of the polarizing film. Further, as shown in FIG. 12, also effective is a constitution in which a spacer (7) having the same thickness as that of a polarizing film and having a size larger slightly than that of the polarizing film is sandwiched between transparent substrates (1) and (2), and gaps between the spacer and the polarizing film are filled with a sealing material.

Also in the case of a polarizing film having a protective film only on one surface of a polarizer, sealing is performed in an analogous manner to the constitution having a protective film on both surfaces of a polarizer. For example, a constitution having a protective film on both surfaces of a polarizer is shown in FIG. 11, and a constitution having a protective film on one surface thereof is shown in FIG. 13.

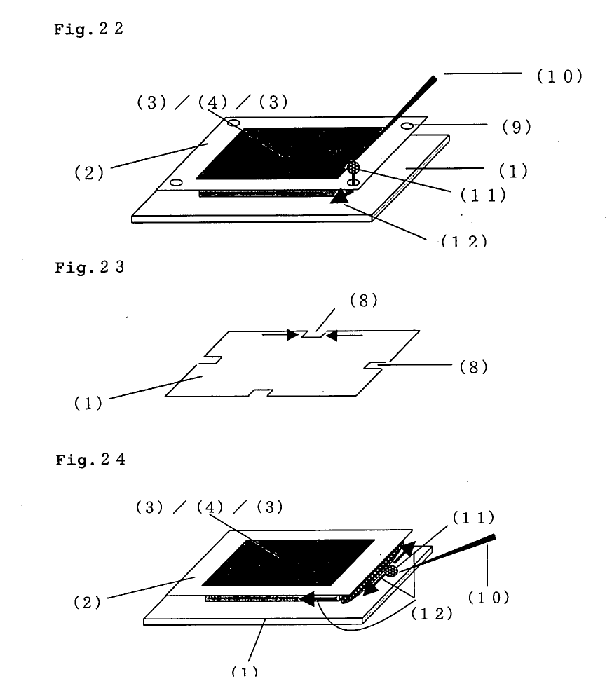

When an exposed portion of a polarizing film exists in a space surrounded by transparent substrates on both sides and the polarizing film (FIG. 11 and FIG. 13), a sealing material may be charged into the space through a concave defective part and/or hole part of the transparent substrate as described above (for example, FIG. 22), and when such parts are not present, even if a sealing material is charged directly into the space, the sealing material flows on the exposed part owing to capillary phenomenon to attain covering (FIG. 24).

Next, a polarizing sheet having a protective film and in which a transparent substrate pasted to a polarizer is a transparent substrate made of a material having no optical anisotropy will be illustrated.

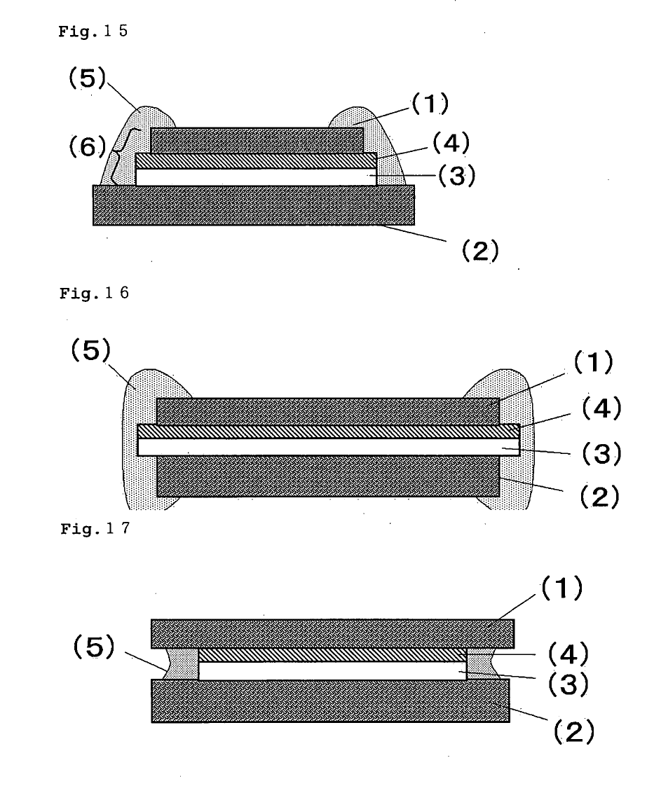

In the case of the constitution shown in FIG. 15, namely, if a polarizing film is smaller than a transparent substrate (2) and a transparent substrate (1) is smaller than the polarizing film, then, portions of the polarizing film contacting air, specifically, the cross-section of a polarizing sheet and parts of the surface (6) not covered by the transparent substrate (1) are covered with an organic and/or inorganic sealing material (5) for blocking contact with air. The sealing material is usually formed on outer peripheral regions of the polarizing sheet, and when the polarizing sheet is, for example, quadrangle, the sealing material covers all of the four sides.

When a polarizing film is larger than transparent substrates (1) and (2) as shown in FIG. 16, it is necessary that the cross-section and the surface of the polarizing film are, including parts of the transparent substrates, covered with a sealing material.

Further, when a polarizing film is smaller than transparent substrates (1) and (2) as shown in FIG. 17, the same effect is obtained by covering only the cross-section of the polarizing film.

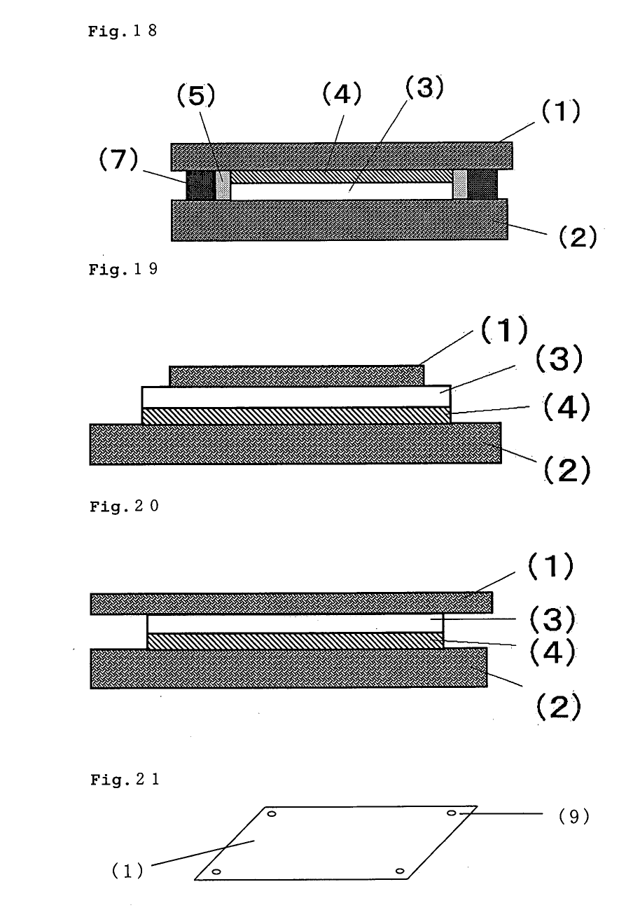

Further, as shown in FIG. 18, also effective is a constitution in which a spacer (7) having the same thickness as that of a polarizing film and having a size larger slightly than that of the polarizing film is sandwiched between transparent substrates (1) and (2), and gaps between the spacer and the polarizing film are filled with a sealing material. Also in the case of a polarizing film having a protective film on both surfaces of a polarizer, the same constitution as that of a case having a protective film only on one surface of a polarizer is possible.

The constituent elements of a polarizing sheet of the present invention will be illustrated.

### (Polarizer)

As the polarizer of the present invention, there can be used those obtained by allowing a dichroic dye or iodine to be adsorbed on and oriented in a polarizer base material such as polyvinyl alcohol resins, polyvinyl acetate resins, ethylene/vinyl acetate (EVA) resins, polyamide resins, polyester resins and the like.

Here, the polyvinyl alcohol resins include polyvinyl alcohol which is a partially or completely saponified substance of polyvinyl acetate; saponified substances of copolymers of vinyl acetate with other copolymerizable monomers (for example, olefins such as ethylene and propylene, unsaturated carboxylic acids such as crotonic acid, acrylic acid, methacrylic acid and maleic acid, unsaturated sulfonic acids, vinyl ethers and the like) such as saponified EVA resins and the like; polyvinyl formal and polyvinyl acetal obtained by modifying polyvinyl alcohol with aldehydes, and the like. As the polarizer base material, films made of polyvinyl alcohol resins, particularly, a film made of polyvinyl alcohol itself is used suitably from the standpoint of absorption and orientation properties of a dye.

As the material to be adsorbed on and oriented in the polarizer base material, dichroic dyes are preferable from the standpoint of light resistance. By use of dyes of different wavelength dependencies, it is possible to manufacture polarizers for blue channel, green channel and red channel, respectively, of a projection type liquid crystal display.

As the dichroic dye, compounds described in “Ekisho hyojisouchi yo nishokusei shikiso no kaihatsu (development of dichroic coloring matter for liquid crystal display)” (Kayane et al., Sumitomo Chemical Co., Ltd., 2002-II, pp. 23 to 30) are mentioned.

Specifically mentioned are dichroic dyes of the formula (I) in the form of free acid:

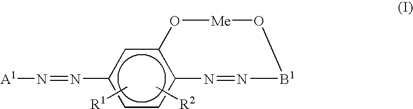

(wherein, Me represents a metal atom selected from a copper atom, nickel atom, zinc atom and iron atom. A¹ represents a phenyl group optionally substituted or a naphthyl group optionally substituted. B¹ represents a naphthyl group optionally substituted, and an oxygen atom bonded to Me and an azo group represented by —N═N— are connected to carbons situated at mutually adjacent positions on a benzene ring. R¹ and R² represent each independently an alkyl group having 1 to 4 carbon atoms, alkoxyl group having 1 to 4 carbon atoms, carboxyl group, sulfoxy group, sulfoneamide group, sulfonealkylamide group, amino group, acylamino group, halogen atom or nitro group.).

Further mentioned are dichroic dyes of the formula (II) in the form of free acid:

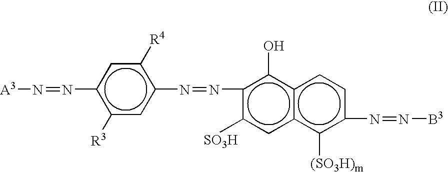

(wherein, A³ and B³ represent each independently a phenyl group optionally substituted or a naphthyl group optionally substituted. R³ and R⁴ represent each independently a hydrogen atom, alkyl group having 1 to 4 carbon atoms, alkoxyl group having 1 to 4 carbon atoms, carboxyl group, sulfoxy group, sulfoneamide group, sulfonealkylamide group, amino group, halogen atom or nitro group, m represents an integer of 0 or 1.).

Furthermore mentioned are dichroic dyes of the formula (III) in the form of free acid:

Q¹-N═N-Q²-X-Q³-N═N-Q⁴ (III)

(wherein, Q¹ and Q⁴ represent each independently a phenyl group optionally substituted or a naphthyl group optionally substituted, and X represents a di-valent residual group of the chemical formula (III-1)

—N═N— (III-1)

or the chemical formula (III-2).

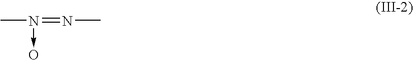

Q² and Q³ represent each independently a phenylene group optionally substituted).

Still further mentioned are dichroic dyes of the formula (IV):

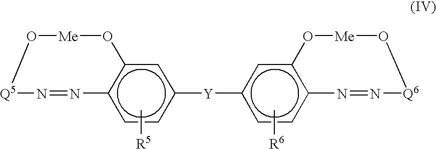

(wherein, Me represents a metal atom selected from a copper atom, nickel atom, zinc atom and iron atom, Q⁵ and Q⁶ represent each independently a naphthyl group optionally substituted, and an oxygen atom bonded to Me and an azo group represented by —N═N— are connected to carbons situated at mutually adjacent positions on a benzene ring. Y represents a di-valent residual group of the formula (IV-1)

—N═N— (IV-1)

or the formula (IV-2).

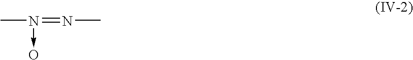

R⁵ and R⁶ represent each independently a hydrogen atom, alkyl group having 1 to 4 carbon atoms, alkoxyl group having 1 to 4 carbon atoms or sulfoxy group.).

Further mentioned are dichroic dyes represented by Color Index Generic Names from the group consisting of C.I. Direct Yellow 12, C.I. Direct Red 31, C.I. Direct Red 28, C.I. Direct Yellow 44, C.I. Direct Yellow 28, C.I. Direct Orange 107, C.I. Direct Red 79, C.I. Direct Red 2, C.I. Direct Red 81, C.I. Direct Orange 26, C.I. Direct Orange 39, C.I. Direct Red 247 and C.I. Direct Yellow 142.

The dichroic dye may be used in the form of free acid, or in the form of amine salt such as an ammonium salt, ethanolamine salt, alkylamine salt and the like, and usually used in the form of alkali metal salt such as a lithium salt, sodium salt, potassium salt and the like.

Such dichroic dyes may be used each singly or in combination of two or more.

As the method for producing a polarizer, the following method is exemplified.

First, a dichroic dye is so dissolved in water as to give a concentration of about 0.0001 to 10 wt % to prepare a dyeing bath. If necessary, a dyeing auxiliary may be used, and for example, a method of using Glauber's salt in a concentration of 0.1 to 10 wt % in a dyeing bath is suitable.

Into thus prepared dyeing bath, a polarizer base material is immersed and dyeing is performed. The dyeing temperature is preferably 40 to 80° C. Orientation of a dye is carried out by stretching a polarizing film base material before dyeing or a polarizer base material dyed. As the dyeing method, mentioned are, for example, methods of stretching in wet mode or dry mode, and the like.

For the purpose of improving the light transmittance, degree of polarization and light resistance of a polarizer, a post treatment such as a boric acid treatment and the like may be performed. In the boric acid treatment, usually, a boric acid aqueous solution prepared at a concentration in the range of 1 to 15 wt %, preferably 5 to 10 wt % is used, and a polarizing film base material is immersed therein at a temperature in the range of 30 to 80° C., preferably 50 to 80° C., though varying depending on the kind of a polarizer base material to be used and the kind of a dye to be used. Further, if necessary, a fixing treatment may be carried out together using an aqueous solution containing a cationic polymer compound.

In the present invention, the water content of a polarizer contained in a polarizing sheet is preferably 5 wt % or less, further preferably 1 wt % or less. When the water content is 5 wt % or less, decomposition of a dye can be suppressed remarkably and the light resistance of the resulting polarizing sheet can be significantly improved, in the case of a polarizer manufactured by adding a dichroic dye to PVA.

The specific method for measuring the water content of a polarizer is a method for calculating the proportion of weight reduction obtained by drying by air flow at 130° C. for 30 minutes under condition of exposure of the polarizer.

For example, the weight (W1) of a polarizer is measured, and the weight (W2) of a polarizing sheet obtained by drying by air flow at 130° C. for 30 minutes under condition of exposure of the polarizer, and the proportion is calculated by the following formulation:

(water content, %)=[(W1−W2)/W1]×100

### (Sealing Material)

As the sealing material used in a polarizing sheet in the present invention, exemplified are those manifesting flowability in processing and hardening after processing to show a sealing function, for example, ultraviolet ray-hardening type resins and thermosetting type resins, and resins hardening by both functions, and the like.

When a resin manifesting flowability in processing is used, the viscosity before hardening of this resin is 20 Pa·s or less, preferably 0.01 Pa·s or more and 5 Pa·s or less. By use of a resin having a viscosity of 20 Pa·s or less, time required for sealing is shortened by its high flowability, and by use of a resin having a viscosity of 0.01 Pa·s or more, flowing out of a sealing material onto a transparent substrate or outer parts in sealing can be prevented. Here, the viscosity is a value measured by JIS K 6249.

The content of volatile components in a sealing material before hardening is preferably 2 wt % or less, further preferably 1 wt % or less. When the content of volatile components is 2 wt % or less, generation of fine bubbles in a sealing material is suppressed and simultaneously, coating of a sealing material under reduced pressure comes to possible, thereby, processing yield can be improved significantly.

The preferable glass transition temperature after hardening of a sealing material is 80° C. or higher, more preferably about 120 to 200° C., and the preferable boiling water absorption coefficient is 4 wt % or less, more preferably 2 wt % or less, further preferably 1 wt % or less. By use of a sealing material having such glass transition temperature, heat resistance is improved and simultaneously, invasion of moisture from air into a polarizer can be suppressed, thereby, the light resistance of the resultant polarizing sheet can be improved.

Here, the boiling water absorption coefficient means a percentage of the increased weight after immersion of a hardened substance in boiling water for 1 hour based on the weight of the hardened substance before immersion, and obtained according to JIS K 6911.

When a sealing material is laminated between transparent substrates and a polarizer as shown in FIGS. 4 to 6, the light transmittance at from 400 nm to 750 nm with a thickness of the sealing material of 25 μm is preferably 90% or more, further preferably 93% or more. It is preferable that the light transmittance is 90% or more since, then, attenuation of transmitted light is small, utilization efficiency is improved, and the brilliance of a screen is improved in installing a polarizing sheet on an actual device.

Specific examples of sealing materials satisfying the above-described viscosity conditions and transmittance conditions include polyolefin-based adhesives such as ethylene-acid anhydride copolymers (for example, BYNEL (registered trademark, Dupont)) and the like, thermosetting adhesives such as epoxy resin-based adhesives (for example, epoxy resin EP582 manufactured by CEMEDINE Co., Ltd., ultraviolet ray-hardening epoxy resin KR695A manufactured by ADEKA, ultraviolet ray-hardening resin XNR5542 manufactured by Nagase Chemtex Corporation), urethane resin-based adhesives, phenol resin-based adhesives and the like, and ultraviolet ray-hardening adhesives such as silicone resins (for example, ultraviolet-hardening resin FX-V550 and FX-V-540 manufactured by ADEKA, ultraviolet ray-hardening type silicone, silicone RTV, silicone rubber, modified silicone resin having a silyl group-ended polyether), cyano acrylate, acrylic resins and the like.

The water vapor transmision rate of a sealing material after hardening is preferably 60 g/m²·24 hr or less under environments of a temperature of 40° C. and a relative humidity of 90% when the thickness is 100 μm, and further preferably it is 25 g/m²·24 hr or less. By this, invasion of moisture from air into the polarizer can be suppressed, and the light resistance of the resultant polarizing sheet can be improved. The water vapor transmision rate means the amount of water passing through a hardened substance in 24 hours per 1 m² of cross-section and measured according to JIS Z 0208.

### (Transparent Substrate)

The material of two transparent substrates constituting a polarizing sheet of the present invention is usually an inorganic transparent material, and specifically exemplified are silicate glass, borosilicate glass, titanosilicate glass, fused silica (quarts glass), quartz crystal, sapphire, YAG (Yttrium-aluminum-garnet) crystal, fluorite and the like. The silicate glass is marketed under the name of white plate glass or blue plate glass for optical material.

One preferable embodiment of the present invention is a case in which at least one of transparent substrates is made of a material having a thermal conductivity coefficient of 5 W/mK or more. When the thermal conductivity coefficient is 5 W/mK or more, heat generated in a polarizer can be discharged efficiently into the substrate to lower the temperature of the polarizer, thereby, the light resistance of a polarizing sheet can be improved. Examples of the material having a thermal conductivity coefficient of 5 W/mK or more include specifically, quartz crystal, sapphire and YAG crystal.

Regarding a specific combination of materials of two transparent substrates constituting a polarizing sheet of the present invention, it is further preferable that one of the transparent substrates is made of sapphire or quartz crystal of high thermal conductivity, and the other transparent substrate is made of quartz crystal, fused quartz, silicate glass or borosilicate glass from the standpoint of suppression of cost at low level.

The thickness of a transparent substrate is preferably 0.05 mm to 3 mm, further preferably 0.08 to 2 mm from the standpoint of yield in industrialization and matching in size with a projector optical system to be applied. A thickness of 0.05 mm or more is preferable since, then, breakage of glass in processing is suppressed and stable production is possible, and a thickness of 3 mm or less is preferable since, then, the resulting polarizing sheet can be miniaturized and can get reduced weight.

It is desirable that a reflection preventing treatment corresponding to the wavelength of light to be used is performed on surfaces in contact with air of a transparent substrate pasted on both surfaces of a polarizer. As the reflection preventing treatment, there are mentioned, for example, a method using a dielectric multi-layered membrane by a sputtering method or vacuum vapor deposition method, and a method of imparting one or more low refractive index layers by coating, and the like. Further, a stain-preventing treatment for preventing adhesion of stain on the surface may be performed on the reflection preventing surface. This is made possible, for example, by imparting to the surface a thin membrane layer containing fluorine in an amount scarcely affecting a reflection preventing performance.

### (Protective Film)

The polarizing film of the present invention can contain a protective film in addition to a polarizer. When the polarizing film contains a protective film, the polarizing film is obtained by pasting a protective film on one surface or both surfaces of a polarizer. Pasting a protective film to a polarizing film is preferable since, then, the mechanical strength of the polarizing film is improved and handling of the polarizing film in production is improved (not broken easily).

When a protective film is pasted to both surfaces of a polarizer, heat generated in the polarizer conducts through the protective film to a transparent substrate, therefore, it is preferable that a protective film is pasted only to one surface of a polarizer from the standpoint of improvement in light resistance.

Mentioned as the protective film are acetylcellulose films (TAC film) such as a triacetylcellulose film and the like, polyester resin films, olefin resin films (for example, commercially available from ZEON Corporation under the registered trade name of ZEONOR, and from JSR under the registered trade name of ARTON), polycarbonate resin films, polyether ether ketone resin films, polysulfone resin films, and the like. Of them, preferable are films composed of triacetylcellulose as a main component, and olefin resin films, and particularly preferable are films composed of triacetylcellulose as a main component.

The thickness of the protective film is preferably 10 to 90 μm, particularly preferably 10 to 45 μm. A thickness of 90 μm or less is preferable since, then, the thickness of a polarizing film can be decreased, and a thickness of 10 μm or more is preferable since, then, the strength of a polarizing film can be secured.

The water content of a polarizing film when the polarizing film contains a protective film is 1.6 wt % or less, preferably 1.2 wt % or less since, then, light resistance tends to increase.

Here, the water content of a polarizing film is the weight of water based on the total weight of a polarizing film containing a polarizer and a protective film, an adhesive for pasting the polarizing film and transparent substrates, and a sealing material. Usually, the use amount of an adhesive and a sealing material is small and the water content is small, however, since the amount of a commercially available protective film is about 4 wt %, the amount of a polarizing film containing this is controlled to 1.6 wt % or less, preferably 1.2 wt % or less.

The water content of a polarizing film represents the proportion of weight reduction obtained by drying by air flow at 130° C. for 30 minutes under condition of exposure of the polarizing film based on the total weight of a polarizing film containing a polarizer and a protective film, an adhesive for pasting the polarizing film and transparent substrates, and a sealing material.

For example, the weight (WF1) of a polarizing sheet is measured, and the weight (WF2) is measured obtained by drying by air flow at 130° C. for 30 minutes under condition of exposure of a polarizing film by peeling a transparent substrate of a polarizing sheet and the like, and separately the weight of a transparent substrate on both sides is measured, then, the proportion is calculated by the following formulation:

(water content, %)=[(WF1−WF2)/(WF1−WF0)]×100

Also when the polarizing film contains a protective film, it is preferable that at least one of transparent substrates is made of a material having a thermal conductivity coefficient of 5 W/mK or more, and it is further preferable that the material of one of transparent substrates is quartz crystal or sapphire, and the material of the other substrate is quartz crystal, quartz glass, silicate glass or borosilicate glass. As the polarizing sheet, preferable are those in which resin layers are formed between a transparent substrate made of a material having a thermal conductivity coefficient of 5 W/mK or more and a polarizer, and the total thickness of the resin layers is 0.1 μm or more and less than 10 μm.

### (Transparent Substrate Made of Material Having No Optical Anisotropy)

When the polarizing film contains a protective film, the polarizing film is composed of one polarizer and one protective film, and the polarizing sheet is formed by pasting a transparent substrate to both surface of the polarizing film, and when the transparent substrate pasted to the polarizer is a transparent substrate made of a material having no optical anisotropy, then, there is a tendency of increase in contrast of an image obtained when used for a projection type liquid crystal display. That is, such a case is preferable.

Here, the term “having no optical anisotropy (referred to retardation in some cases)” means that there is substantially no phase difference between two beams of different polarizing directions among beams passing through the transparent substrate. By use of a transparent substrate “having no optical anisotropy” as the transparent substrate pasted to the polarizer, a polarization surface generated by passing light from a light source through the polarizer is not distorted by a transparent substrate having optical anisotropy. Therefore, such a use is preferable.

As the material of such transparent substrates, exemplified are silicate glass, borosilicate glass and the like.

The transparent substrate pasted to a protective film may have or may not have optical anisotropy since incident light before passing through a polarizer passes through this substrate. For improving the light resistance of a polarizing sheet, the material of the transparent substrate pasted to a protective film is preferably a material having a thermal conductivity coefficient of 5 W/mK or more, more preferably quartz crystal or sapphire, particularly preferably sapphire.

### (Resin Layer)

The polarizing sheet of the present invention is a polarizing sheet having a transparent substrate on both surfaces of a polarizing film containing a polarizer in which at least a resin layer for adhesion is usually present between the polarizing film and the transparent substrate.

In, for example, FIG. 1, resin layers (a) and (c) are resin layers formed between transparent substrates and a polarizing film, the resin layer being in direct contact with the transparent substrate.

In the present invention, one preferable embodiment is a polarizing sheet having a transparent substrate on both surfaces of a polarizer in which at least one of transparent substrates is made of a material having a thermal conductivity coefficient of 5 W/mK or more, and exposed portions of the polarizer not covered by the transparent substrate are covered with a resin.

In the present invention, one preferable embodiment is a polarizing sheet having a structure of lamination of two or more resin layers including an adhesive layer between a polarizer and at least one of transparent substrates. Hereinafter, this part is called lamination part in some cases, and for example, in FIG. 1, corresponds to resin layers (b) and (c). The adhesive layer contained in the lamination part is a resin layer directly contacting a transparent substrate among resin layers forming the lamination part, and in FIG. 1, corresponds to the resin layer (c). The resin layer (b) also has an adhesion function, however, the mechanical strength thereof is high, thus, it has a function of protecting a polarizer. When the lamination part is formed between a polarizing film and a transparent substrate, the mechanical strength of a polarizer increases even if a protective film is not used, and occurrence of a problem of generation of crack in producing a polarizing sheet, and the like can be suppressed, and the light resistance of a polarizing sheet is improved in actual use. That is, such a constitution is preferable.

The total thickness of the lamination part is preferably 1 μm or more and 30 μm or less, further preferably 1 μm or more and 10 μm or less. A thickness is 1 μm or more is preferable since, then, the strength of a resin layer can be ensured and thus production thereof becomes easy, and sufficient adhesive force with a transparent substrate can be ensured. A total thickness of the laminated part of 30 μm or less is preferable since, then, heat generated in a polarizer conducts to a transparent substrate easily, thereby, the temperature of a polarizing sheet lowers, resultantly, light resistance is improved.

In the present invention, either an ultraviolet ray-hardening resin or a thermosetting resin may be used in the lamination part. In particular, the ultraviolet ray-hardening resin is suitably used since it does not need high temperature condition in a hardening process, thus, the optical performance of a polarizing sheet is not lowered.

The amount of volatile components before hardening of a hardable resin forming the lamination part is preferably 2 wt % or less, further preferably 1 wt % or less. When the amount of volatile components is 2 wt % or less, generation of fine bubbles in a resin layer after processing is suppressed and application of a resin layer under reduced pressure becomes possible, thereby, processing yield can be improved. The viscosity of the resin layer before hardening is preferably 0.01 Pa·s or more and 20 Pa·s or less at 25° C. A viscosity of the resin layer of 20 Pa·s or less is preferable since, then, sufficient flowability can be ensured, flatness of the resin layer can be ensured, and the production time of a polarizing sheet can be shortened.

The light transmittance of a resin layer to be formed in a polarizing sheet, in a wavelength range of 400 nm to 700 nm when the thickness after hardening is 25 μm, is preferably 90% or more, further preferably 93% or more. A light transmittance of 90% or more is preferable since, then, attenuation of transmitted light is small, utilization efficiency is improved, and the brilliance of a screen is improved when a polarizing sheet is installed on a projection type liquid crystal display.

A resin layer other than an adhesive layer contained in the lamination part has mainly a function of protecting a polarizer, and in this case, a protective film is not necessary. This resin layer corresponds, for example, to a resin layer (b) in FIG. 1. The glass transition temperature of the resin layer is preferably 40° C. or higher, and further preferably 60° C. or higher. A glass transition temperature of the resin layer of 40° C. or higher is preferable since, then, particularly in a drying process among polarizing sheet production processes, the strength of a polarizing sheet is ensured, problems of cracking of a polarizer and the like are suppressed, leading to increase in yield. In the resin layer, any of acrylic ultraviolet ray-hardening resins, silicone-based ultraviolet ray-hardening resins, epoxy-based ultraviolet ray-hardening resins and epoxy-based thermosetting resins may be used, and use of an acrylic ultraviolet ray-hardening resin or silicone-based ultraviolet ray-hardening resin in the resin layer is further preferable since, then, the light resistance of a polarizing sheet tends to be further improved.

As shown in FIGS. 4 to 6, a sealing material may be contained in a resin layer forming the lamination part. In this case, the sealing material has also a function as an adhesive layer for adhering a transparent substrate and a resin layer.

In the polarizing sheet of the present invention, when a polarizer is adhered to a transparent substrate having a thermal conductivity coefficient of 5 W/mK or more via a resin layer, the thickness of the resin layer is preferably 0.1 μm or more and less than 10 μm, further preferably 0.1 μm or more and 5 μm or less. A thickness of 0.1 μm or more is preferable since, then, sufficient adhesive force can be ensured between a transparent substrate and a polarizer. A thickness of 5 μm or less is preferable since, then, heat generated in a polarizer conducts easily to a transparent substrate of high heat dischargeability showing a thermal conductivity coefficient of 5 W/mK or more, thereby, the temperature of a polarizing sheet lowers, and light resistance is further improved.

The resin layer formed in this case may be a single layer composed only of an adhesive layer or a composite layer composed of two or more layers made of several resins.

### (Production Method)

The polarizing sheet of the present invention, namely, a polarizing sheet having a transparent substrate on both surfaces of a polarizing film containing a polarizer in which exposed portions of the polarizing film not covered by the transparent substrate are covered with a sealing material, can be produced by carrying out a process of adhering a transparent substrate to both surfaces of a polarizing film using a resin and a process of drying the polarizing film, thereafter, carrying out a process of covering exposed portions of the polarizing film not covered by the transparent substrate, with a sealing material.

Here, a protective film is conventionally pasted to a polarizer before use in production of a polarizing sheet, to protect the polarizer having poor mechanical strength and thereby to prevent breakage thereof during production of a polarizing sheet. However, the protective film disturbs thermal conduction from the polarizer to a transparent substrate. Therefore, the present inventors have intensively studied a method for producing a polarizing sheet which uses no protective film and in which a polarizer is not broken in production. As a result, the present inventors have found that if a thin resin layer showing smaller tendency of disturbing thermal conduction than that of a protective film is formed on at least one surface of a polarizer, breakage of the polarizer can be prevented. By the above-described preferable production method using no protective film according to the present invention, stable high yield can be ensured, and additionally, industrial production of a polarizing sheet having particularly high light resistance becomes possible. The particularly preferable production method is a method for producing a polarizing sheet in which a resin layer is formed on one surface of a polarizing film composed of a polarizer, then, the resin layer and a transparent substrate are adhered, and after drying, a second transparent substrate is adhered to a surface carrying no transparent substrate adhered to the polarizing film, and exposed portions not covered by the transparent substrate of the polarizing film are covered with a sealing material.

When a protective film is contained in a polarizing film, a protective film is pasted to a polarizing film before adhering with a transparent substrate.

If a polarizing sheet does not have a protective film and has a lamination part composed of two or more laminated resin layers including an adhesive layer between a polarizing film composed of a polarizer and at least one transparent substrate, then, a resin layer other than the adhesive layer of the lamination part is previously formed on the surface of a polarizing film before adhering of the polarizing film and the transparent substrate via a resin layer.

When a transparent substrate and a polarizing film are adhered, it is preferable that formation of a resin layer as an adhesive layer before hardening and at least one process of setting an object to be adhered are carried out under reduced pressure, to perform production.

More preferable is a production method in which, in drying, a polarizing film is dried at 110° C. or lower before adhering the polarizing film and the second transparent substrate (when the polarizing film carries on its both surfaces resin layers, adhered via a resin layer).

That is, a polarizing film is dried under an atmosphere of 110° C. or lower, for controlling the water content of a polarizer to 5 wt % or lower. As the drying temperature, temperatures in the range of 40 to 110° C. are preferable, and temperatures in the range of 50 to 100° C. are further preferable. This drying process may be carried out at a stage of utterly no adhesion of a transparent substrate to a polarizer or at a stage after adhesion of a transparent substrate to one side or both sides of a polarizing film, and drying under condition of adhesion of a transparent substrate to one side is more preferable since, then, flatness of the polarizing film can be maintained, and removal of water in the polarizing film from the side of no adhesion of a transparent substrate can be carried out rapidly. Further, in this case, there is also a merit that no invasion of water from the transparent substrate side occurs and a polarizer is maintained easily under dry condition. When a polarizing sheet has a lamination part composed of two or more laminated resin layers including an adhesive layer between a polarizer and at least one of transparent substrates, it is preferable to carry out drying under condition in which a transparent substrate is adhered to one side of a polarizing film and a resin layer is formed on the other side carrying no adhered transparent substrate. In this case, generation of crack of a polarizer in the drying process can be prevented, thereby, yield can be improved.

As the drying method, exemplified are a heat drying method, pressure-reduction drying method and the like. As specific examples of the heat drying method, there are, for example, a method of placing into a heat oven, a method in which a polarizing sheet is irradiated with light, and heat generation of a polarizing sheet itself due to light absorption of a polarizer is utilized, and other methods. In a large scale process, preferable are heat drying methods using an oven or irradiation with light from the standpoint of simplicity of the apparatus.

The polarizing sheet of the present invention can be completed if a transparent substrate is adhered after the drying process, and subsequently, exposed portions of a polarizing film not covered by the transparent substrate is covered with a sealing material, and hardening is performed.

Here, if at least one of transparent substrates has a concave defective part and/or hole part for injection of a sealing material and the sealing material is injected through the concave defective part and/or hole part, then, exposed portions of a polarizing film can be covered quickly by a capillary phenomenon.

If, for example, there is a hole part at a position approximately near the center on the top of a transparent substrate as shown in FIG. 21, a polarizing sheet is pasted according to an assembly view as shown in FIG. 22 before injection of a sealing material through the hole part, then, the sealing material moves along a side from the concave defective part to exposed portions having a height of about 10 μm to 300 μm provided by transparent substrates on both sides and a depth of about 0.5 mm to 20 mm from the outer edge of the transparent substrate to the polarizing film, and the sealing material is hardened as described later, thus, a polarizing sheet having cross-section shown in FIG. 3 can be obtained. The size of the hole part is about 0.01 to 2 mm.

If there is a concave defective part approximately at the center of a side of a transparent substrate as shown in FIG. 23, then, a sealing material is charged through the concave defective part in an analogous manner, thus, a polarizing sheet having cross-section shown in FIG. 3 can be obtained. As the shape of the concave defective part, U character form, triangle form, hemicycle form and the like are mentioned in addition to the form of Japanese Katakana character [symbol] as shown in FIG. 23. Regarding the size of the concave defective part, the size of the maximum defective part is controlled to about 0.01 to 2 mm.

A necessary number of concave defective parts and hole parts are provided for sufficient covering of exposed portions surrounded by transparent substrates on both surfaces and a polarizing film with a sealing material, and one or more concave defective parts are provided on one side or one hole part is provided on one peak.

A concave defective part and a hole part may be present simultaneously on a transparent substrate. The concave defective part and hole part can be made by using a diamond tool or by a laser optical processing apparatus on a transparent substrate.

### (Constitution of Projector)

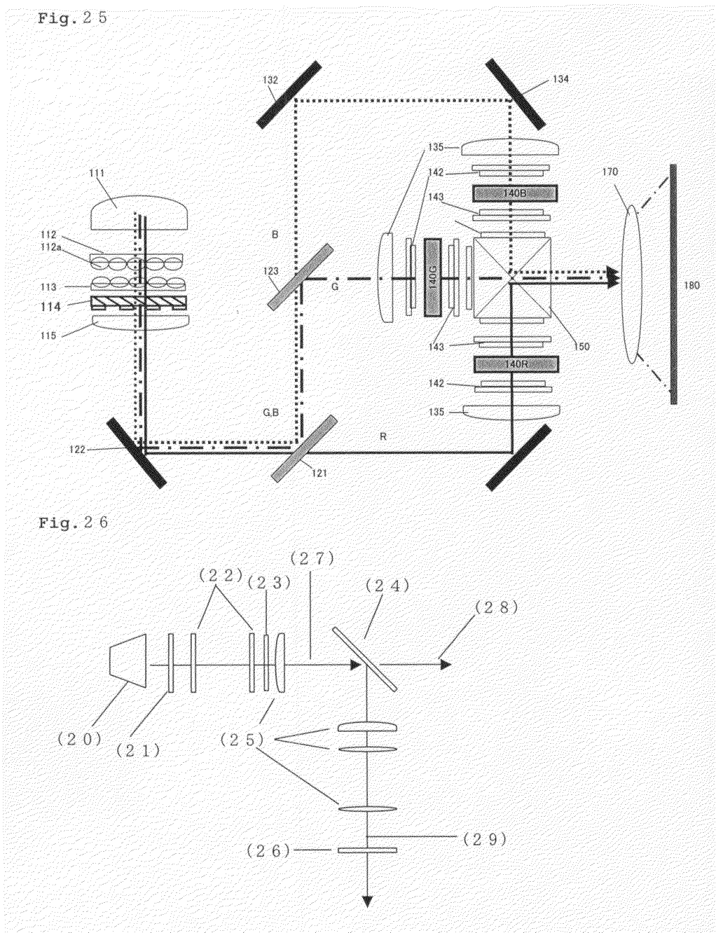

The polarizing sheet of the present invention is used, for example, in a projection type liquid crystal display (projector). The details thereof are explained using an optical system of a rear projector shown in FIG. 25 as an examples. The polarizing sheet of the present invention is exemplified as 142, 143 in FIG. 25.

A beam bundle from a high pressure mercury lamp 111 as a light source is, first, uniformalized in brilliance and polarized at cross-section of opposite beam bundle by a first lens array 112, a second lens array 113, a polarization converting element 114 and an superimposed lens 115.

Specifically, a beam bundle outgoing from the light source 111 is divided into a number of fine beam bundles by the first lens array 112 having fine lenses 112a disposed in the form of matrix. The second lens array 113 and the superimposed lens 115 are so provided that respective divided beam bundles irradiate all of three LCD panels 140R, 140G and 140B as an irradiation subject, and by this constitution, all surfaces of respective LCD panel incident sides show approximately uniform illuminance.

The polarization converting element 114 is usually constituted of a polarizing beam splitter array, and placed between the second lens array 113 and the superimposed lens 115. This performs a role by which random polarization from the light source is previously converted into a polarized light having a specific polarization direction, and light quantity loss at a polarizing sheet at the incident side described later is lowered, thus, brilliance of a screen is improved.

The light uniformalized in brilliance and polarized passed through a reaction mirror 122 and divided into a red channel, green channel and blue channel sequentially by dichroic mirrors 121, 123 and 132 for separation into RGB three primary colors, which enter LCD panels 140R, 140G and 140B, respectively.

For the LCD panels 140R, 140G and 140B, polarizing sheets (incident side) 142 and polarizing sheets (outgoing side) 143 of the present invention are placed, respectively, at the incident side and the outgoing side.

Two polarizing sheets placed at the incident side and outgoing side sandwiching a liquid crystal panel in respective RGB light paths will be explained. The polarizing sheets (incident side) and polarizing sheets (outgoing side) placed in respective light paths are placed under a configuration of crossing of their absorption axes, and play a function by which polarizing conditions controlled for respective pixels by image signals at respective LCD panels 140R, 140G and 140B placed in respective light paths are converted into light quantities.

The polarizing sheet of the present invention has a constitution common to all light paths of a blue channel, green channel and red channel, and is effective as a polarizing sheet of excellent durability in every light paths, and among them, particularly effective in a blue channel and green channel.

Optical images produced by allowing incident lights to transmit at different transmission factors for respective pixels according to image data of LCD panels 140R, 140G and 140B are combined by a cross dichroic prism 150, and enlarged and projected to screen 180 by a projection lens 170.

The polarizing sheet of the present invention is a polarizing sheet suitable for a projection type liquid crystal display such as a front projector, rear projector and the like because of excellent light resistance, and shows long life particularly when used in a projection type liquid crystal display of high brilliance. Further, according to the production method of the present invention, the polarizing sheet of the present invention can be produced easily, thus, the present invention is industrially extremely useful.

### EXAMPLES

The present invention will be illustrated based on examples below, but it is needless to say that the present invention is not limited to these examples.

### Example 1

A polyvinyl alcohol film (VF-PX manufactured by Kuraray Co., Ltd., hereinafter referred to as PVA) was stretched uni-axially, dyed with a dye absorbing blue color, and dried to obtain a polarizer for projector blue channel showing a degree of polarization of 99.9% and a transmittance of 44.0% at a thickness of 28 μm and a wavelength of 440 nm. This polarizer was pasted to a sapphire substrate (manufactured by Kyocera Corporation) having a thickness of 0.5 mm and a thermal conductivity coefficient of 40 W/mK under reduced pressure via an acrylic ultraviolet ray-hardening adhesive (MO5 manufactured by Adell). At this stage, the adhesive layer had a thickness of 5 μm. Next, a silicone-based ultraviolet ray-hardening resin (FXV550 manufactured by ADEKA) was applied on the upper surface of the polarizer and hardened to form a resin layer having a thickness of 10 μm. While keeping this condition, the layer was dried in an over of 50° C. for 72 hours to control the water content of the polarizer to 1.2 wt % or less. After drying, the upper surface of the resin layer and blue plate glass (silicate glass) were pasted under reduced pressure using an acrylic ultraviolet ray-hardening resin (MO5 manufactured by Adell). At this stage, a lamination part was formed between the blue plate glass and the polarizer and the thickness thereof was 15 μm. Thereafter, a thermosetting epoxy resin (EP582 manufactured by CEMEDINE Co., Ltd., water vapor transmission rate: 20 g/m²·24 hr) was applied as a sealing material under reduced pressure so as to cover exposed portions of the polarizer, and hardened to obtain a polarizing sheet having the same constitution as that of the schematic view of FIG. 1. On the surfaces of the sapphire substrate and blue plate glass used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 80 to 120 hours (hereinafter, this evaluation is referred to as initial evaluation in some cases). Further, the resultant sample was left under environments of a temperature of 60° C. and a relative humidity of 90% for 72 hours, thereafter, light resistance thereof was evaluated in an analogous manner, to find no generation of light leakage (hereinafter, this evaluation is referred to as long period evaluation in some cases).

The light resistance evaluation apparatus used in this procedure used a high pressure mercury lamp of 130 W manufactured by Phillips as a light source and had the same optical systems as those of rear projection TV such as a polarizing beam splitter array and lenticular lens and the like, and the irradiation light quantity on the polarizing sheet was 3.0 W per 1 cm².

Here, the light leakage is a deterioration phenomenon of a polarizing sheet occurring after setting in a light path of a light resistance evaluation apparatus in which transmittance along the absorption axis increases. When a polarizing sheet as the evaluation subject and a normal polarizing sheet are placed in Cross-Nicole mode, transmittance should be low fundamentally, however, light leaks and is transmissive in this case, accordingly, the phenomenon is expressed as “light leakage”.

### Example 2

A polarizer obtained in the same manner as in Example 1 was pasted to a sapphire substrate (manufactured by Kyocera Corporation) having a thickness of 0.5 mm and a thermal conductivity coefficient of 40 W/mK under reduced pressure via an acrylic ultraviolet ray-hardening adhesive (MO5 manufactured by Adell). At this stage, the adhesive layer had a thickness of 5 μm. Next, a silicone-based ultraviolet ray-hardening resin (FXV550 manufactured by ADEKA) was applied on the upper surface and side surface of the polarizer and hardened to form a resin layer having a thickness of 5 μm. While keeping this condition, the layer was dried in an over of 60° C. for 24 hours to control the water content of the polarizer to 1.2 wt % or less. After drying, the upper surface of the resin layer and quartz crystal having a thermal conductivity coefficient of 8 W/mK were pasted under reduced pressure using an epoxy-based ultraviolet ray-hardening resin (KR695A manufactured by ADEKA, water vapor transmission rate: 50 g/m²·24 hr), and simultaneously, the side surface of the polarizer was covered from over the above-described silicone-based ultraviolet ray-hardening resin hardened substance, to obtain a polarizing sheet having a constitution shown in FIG. 5. At this stage, a lamination part was formed between the quartz crystal and the polarizer and the thickness thereof was 10 μm. On the surfaces of the sapphire substrate and quartz crystal used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 120 to 160 hours (hereinafter, this evaluation is referred to as initial evaluation in some cases). Further, the resultant sample was left under environments of a temperature of 60° C. and a relative humidity of 90% for 72 hours, thereafter, light resistance thereof was evaluated in an analogous manner, to find no generation of light leakage.

### Example 3

A polarizer obtained in the same manner as in Example 1 was pasted to quartz crystal having a thickness of 0.5 mm and a thermal conductivity coefficient of 8 W/mK under reduced pressure via an acrylic ultraviolet ray-hardening adhesive (MO5 manufactured by Adell). At this stage, the adhesive layer had a thickness of 5 μm. Next, a silicone-based ultraviolet ray-hardening resin (FXV550 manufactured by ADEKA) was applied on the upper surface and side surface of the polarizer and hardened to form a resin layer having a thickness of 5 μm. While keeping this condition, the layer was dried in an over of 70° C. for 12 hours to control the water content of the polarizer to 1.2 wt % or less. After drying, the upper surface of the resin layer and quartz crystal were pasted under reduced pressure using an acrylic ultraviolet ray-hardening resin (MO5 manufactured by Adell). At this stage, a lamination part was formed between the quartz crystal and the polarizer and the thickness thereof was 10 μm. Thereafter, a thermosetting epoxy resin (EP582 manufactured by CEMEDINE Corporation, water vapor transmission rate: 20 g/m²·24 hr) was applied as a sealing material under reduced pressure so as to cover the side surface of the polarizer from over the above-described silicone-based ultraviolet ray-hardening resin hardened substance and hardened to obtain a polarizing sheet having the same constitution as that of the schematic view of FIG. 2. On the surfaces of the quartz crystal used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 40 to 80 hours (hereinafter, this evaluation is referred to as initial evaluation in some cases). Further, the resultant sample was left under environments of a temperature of 60° C. and a relative humidity of 90% for 72 hours, thereafter, light resistance thereof was evaluated in an analogous manner, to find no generation of light leakage.

### Example 4

A polarizer obtained in the same manner as in Example 1 was pasted to quartz crystal having a thickness of 0.5 mm and a thermal conductivity coefficient of 8 W/mK under reduced pressure via an acrylic ultraviolet ray-hardening adhesive (MO5 manufactured by Adell). At this stage, the adhesive layer had a thickness of 5 μm. Next, a silicone-based ultraviolet ray-hardening resin (FXV550 manufactured by ADEKA) was applied on the upper surface and side surface of the polarizer and hardened to form a resin layer having a thickness of 5 μm. While maintaining this configuration, the layer was dried in an over of 80° C. for 6 hours to control the water content of the polarizer to 1.2 wt % or less. After drying, the upper surface of the resin layer and blue plate glass were pasted under reduced pressure using a thermosetting epoxy resin (EP582 manufactured by CEMEDINE Corporation, water vapor transmission rate: 20 g/m²·24 hr) and simultaneously, the side surface of the polarizer was covered from over the above-described silicone-based ultraviolet ray-hardening resin hardened substance, to obtain a polarizing sheet having a constitution shown in FIG. 5. At this stage, a lamination part was formed between the blue plate glass and the polarizer and the thickness thereof was 10 μm. On the surfaces of the quartz crystal and blue plate glass used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 30 to 70 hours (hereinafter, this evaluation is referred to as initial evaluation in some cases). Further, the resultant sample was left under environments of a temperature of 60° C. and a relative humidity of 90% for 72 hours, thereafter, light resistance thereof was evaluated in an analogous manner, to find no generation of light leakage.

### Comparative Example 1

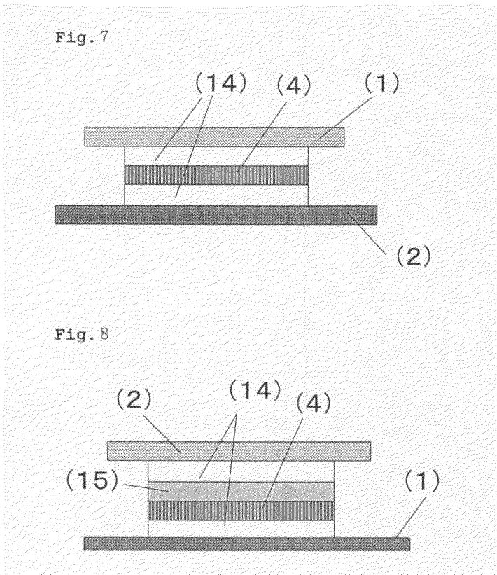

Onto one surface of a polarizer obtained in the same manner as in Example 1, a sapphire substrate (manufactured by KYOCERA Co., Ltd.) having a thickness of 0.5 mm and a thermal conductivity coefficient of 40 W/mK was pasted under reduced pressure using an acrylic ultraviolet ray-hardening adhesive (MO5 manufactured by Adell), and via no drying process, blue plate glass having a thickness of 0.5 mms was pasted to the other surface using an acrylic ultraviolet ray-hardening resin (MO5 manufactured by Adell), to obtain a laminated body having a side surface not covered with a sealing material (its constitution is shown in FIG. 7). At this stage, the adhesive layer had a thickness of 5 μm. The side surface of this laminated body has a constitution of coming into contact with air. On the surfaces of the sapphire substrate and blue plate glass being in contact with air, a reflection preventing treatment was performed with 5 layers of dielectric substances by vacuum vapor deposition.

When light resistance was evaluated in the same manner as in Example 1, light leakage due to deterioration of the polarizer occurred in only 8 to 15 hours in the stage of the initial evaluation, and further, when the polarizer was left under environments of a temperature of 60° C. and a relative humidity of 90% for 72 hours and then the same light elevation was carried out, deterioration progressed rapidly. The results are summarized in Table 1.

### Comparative Example 2

Onto one surface of a polarizer obtained in the same manner as in Example 1, a sapphire substrate (manufactured by KYOCERA Co., Ltd.) having a thickness of 0.5 mm and a thermal conductivity coefficient of 40 W/mK was pasted under reduced pressure using an acrylic ultraviolet ray-hardening adhesive (MO5 manufactured by Adell). Thereafter, a silicone-based ultraviolet ray-hardening resin (FXV550 manufactured by ADEKA) was applied to the upper surface of the polarizer and hardened to form a resin layer having a thickness of 10 μm. This laminated body was dried at 60° C. for 24 hours, then, quartz crystal having a thickness of 0.5 mms was pasted to the other surface using an acrylic ultraviolet ray-hardening resin (MO5 manufactured by Adell), to obtain a laminated body having a side surf ace not covered with a sealing material (its constitution is shown in FIG. 8). At this stage, a lamination part was formed between the blue plate glass and the polarizer and its thickness was 15 μm. Under this constitution, the side surface of the laminated body comes into contact with air. On the surfaces of the sapphire substrate and quartz crystal being in contact with air, a reflection preventing treatment was performed with 5 layers of dielectric substances by vacuum vapor deposition.

When light resistance was evaluated in the same manner as in Example 1, light leakage due to deterioration of the polarizer occurred in 20 to 50 hours in the stage of the initial evaluation, and further, when the polarizer was left under environments of a temperature of 60° C. and a relative humidity of 90% for 72 hours and then the same light elevation was carried out, deterioration progressed rapidly. The results are summarized in Table 1.

### Example 15

A polarizer obtained in the same manner as in Example 1 was pasted to sapphire having a thickness of 0.5 mm and a thermal conductivity coefficient of 40 W/mK under reduced pressure via an acrylic ultraviolet ray-hardening adhesive (MO5 manufactured by Adell). At this stage, the adhesive layer had a thickness of 5 μm. While keeping this condition, the layer was dried in an over of 80° C. for 6 hours to control the water content of the polarizer to 1.2 wt % or less. After drying, the upper surface of the resin layer and blue plate glass were pasted under reduced pressure via an acrylic ultraviolet ray-hardening adhesive (MO5 manufactured by Adell). Thereafter, the side surface of the polarizer was covered using a thermosetting epoxy resin (EP 582 manufactured by CEMEDINE: water vapor transmission rate: 20 g/m²·24 hr), to obtain a polarizing sheet having a constitution shown in FIG. 7. At this stage, a lamination part was formed between the blue plate glass and the polarizer and the thickness thereof was 15 μm. On the surfaces of the quartz crystal and blue plate glass used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 11, and time until generation of light leakage due to deterioration was checked to find a result of 80 to 120 hours (hereinafter, this evaluation is referred to as initial evaluation in some cases). Further, the resultant sample was left under environments of a temperature of 60° C. and a relative humidity of 90% for 72 hours, thereafter, light resistance thereof was evaluated in an analogous manner, to find no generation of light leakage.

TABLE 1

| | Constitution of | | | | | | |
|---|---|---|---|---|---|---|---|
| | transparent | | | | | | |
| | substrate | | Thickness | | | | |
| | transparent | Thickness | of | | Constitution | Evaluation of light | |
| | substrate | of | adhesive | | of | resistance | |
| | (A)/transparent | lamination | layer (a) | Drying | polarizing | Initial | Long |
| | substrate (B) | part | *1 | condition | sheet | period | period |
| Example | | | | | | | ∘ |
| 1 | sapphire/blue | 15 μm | 5 μm | 60° C. × 24 hr | FIG. 1 | 80 to 120 hr | ∘ |
| | plate glass | | | | | | |
| 2 | sapphire/quartz | 10 μm | 5 μm | 50° C. × 72 hr | FIG. 5 | 120 to 160 hr | ∘ |
| | crystal | | | | | | |
| 3 | quartz | 10 μm | 5 μm | 70° C. × 12 hr | FIG. 2 | 40 to 80 hr | ∘ |
| | crystal/quartz | | | | | | |
| | crystal | | | | | | |
| 4 | quartz | 10 μm | 5 μm | 80° C. × 6 hr | FIG. 5 | 30 to 70 hr | ∘ |
| | crystal/blue | | | | | | |
| | plate glass | | | | | | |
| 15 | Sapphire/blue | none | 5 μm | 60° C. × 24 hr | FIG. 7 | 90 to 120 hr | ∘ |
| | plate glass | | | | | | |
| Comparative | | | | | | | |
| example | | | | | | | |
| 1 | sapphire/blue | none | 5 μm | none | FIG. 8 | 8 to 15 hr | x |
| | plate glass | | | | | | |
| 2 | sapphire/quartz | 15 μm | 5 μm | 60° C. × 24 hr | FIG. 9 | 20 to 50 hr | x |
| | crystal | | | | | | |

*1 thickness of lamination layer formed between transparent substrate (A) and polarizer

### Example 5

A polyvinyl alcohol film (VF-PX manufactured by Kuraray Co., Ltd., hereinafter referred to as PVA) was stretched uni-axially, dyed with a dye absorbing blue color, and dried to obtain a polarizer for projector blue channel showing a degree of polarization of 99.9% and a transmittance of 44.0% at a thickness of 28 μm and a wavelength of 440 nm. Onto both surfaces of this polarizer, an acetyl cellulose-based film (KC8UY manufactured by Konica Corp., hereinafter referred to as 8UYTAC) having a thickness of 80 μm was pasted as a protective film with an adhesive containing a water-soluble polyamide epoxy resin (product name: Sumirez Resin 650) as an active ingredient in a carboxyl group-modified polyvinyl alcohol resin (product name: KL318), to produce a polarizing film. Onto one surface of the resultant polarizing film, sapphire glass (manufactured by Kyocera Corporation) having a thickness of 0.5 mm was pasted, and dried in an oven of 70° C. for 180 minutes while maintaining this configuration, to control the water content of the polarizing film to 1.2 wt % or less. After drying, onto the other TAC surface, blue plate glass of 0.1 mm was pasted. Thereafter, an ultraviolet ray-hardening resin was applied so as to cover the section and exposed portions of the polarizing sheet, and hardened to obtain a polarizing sheet having the same constitution as that of the schematic view of FIG. 9. On surfaces of both the sapphire glass and blue plate glass used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 65 hours. Further, the resultant sample was left under environments of a temperature of 60° C. and a relative humidity of 90% for 72 hours, thereafter, light resistance thereof was evaluated in an analogous manner, to find no deterioration of light resistance.

### Example 6

Onto one surface of the polarizer (PVA) of the polarizing film obtained in the same manner as in Example 5, 8UYTAC was pasted with an epoxy-based adhesive, and onto the other surface, an olefin resin film (Zeonor: registered trade mark, manufactured by ZEON Corporation, thickness 40 μm) was pasted, to produce a polarizing film. Onto the Zeonor side of the resultant polarizing film, sapphire glass (manufactured by Kyocera Corporation) having a thickness of 0.5 mm was pasted via an adhesive, and dried in an oven of 80° C. for 120 minutes, to control the water content of the polarizing film to 1.2 wt % or less. Next, onto the 8UYTAC side, blue plate glass of 0.1 mm was pasted. Thereafter, the side surface of the resultant laminated body was covered with an ultraviolet ray-hardening resin, to obtain a polarizing sheet having a constitution shown in FIG. 11. On surfaces of both the sapphire glass and blue plate glass being in contact with air, a reflection preventing treatment was performed with 5 layers of dielectric substances by vacuum vapor deposition.

The same light resistance evaluation as in Example 5 was performed, to resultantly find excellent initial evaluation and no deterioration even in long period evaluation. The results are summarized in Table 2 together with Example 5.

### Example 7

Onto only one surface of the same polarizer (PVA) as in Example 1, an acetyl cellulose-based film (KC4UY manufactured by Konica Corp., hereinafter referred to as 4UYTAC) having a thickness of 40 μm was pasted with an epoxy-based adhesive, to produce a polarizing film. Onto the polarizer side of the resultant polarizing film, sapphire glass (manufactured by Kyocera Corporation) having a thickness of 0.5 mm was pasted via an adhesive, and dried in an oven of 80° C. for 120 minutes, to control the water content of the polarizing film to 1.2 wt % or less. Next, onto the 4UYTAC side, blue plate glass of 0.1 mm was pasted, subsequently, the side surface of the resultant laminated body was covered with an ultraviolet ray-hardening resin, to obtain a polarizing sheet having a constitution shown in FIG. 13. On surfaces of both the sapphire glass and blue plate glass being in contact with air, a reflection preventing treatment was performed with 5 layers of dielectric substances by vacuum vapor deposition.

The same light resistance evaluation as in Example 5 was performed, to resultantly find excellent initial evaluation and no deterioration even in long period evaluation. The results are summarized in Table 2.

### Comparative Example 3

Onto one surface of a polarizing film obtained in the same manner as in Example 5, sapphire glass (manufactured by Kyocera Corporation) having a thickness of 0.5 mm was pasted via an adhesive, and through no drying process, onto the other one side was pasted blue plate glass of 0.1 mm, to obtain a laminated body having a side surface not covered with a sealing material (its constitution is shown in FIG. 14. Conventional polarizing sheet). It had at this stage a constitution in which the side surface the laminated body and parts of the surface not covered with blue plate glass were in contact with air. On surfaces of both the sapphire glass and blue plate glass being in contact with air, a reflection preventing treatment was performed with 5 layers of dielectric substances by vacuum vapor deposition.

The same light resistance evaluation as in Example 5 was performed, to find that light leakage due to deterioration of the polarizer occurred in only 12 hours in the procedure of the initial evaluation, further, in the case of being left under environments of a temperature of 60° C. and a relative humidity of 90% for 72 hours, deterioration progressed rapidly and correct data could not be obtained. The results are summarized in Table 2.

### Comparative Example 4

Onto one surface of a polarizing film obtained in the same manner as in Example 5, sapphire glass (manufactured by Kyocera Corporation) having a thickness of 0.5 mm was pasted via an adhesive, and dried in an oven of 80° C. for 120 minutes, then, onto the other one side was pasted blue plate glass of 0.1 mm, to obtain a laminated body having a side surface not covered with a sealing material (its constitution is shown in FIG. 14. Conventional polarizing sheet). It had at this stage a constitution in which the side surface of the laminated body and parts of the surface not covered with blue plate glass were in contact with air. On surfaces of both the sapphire glass and blue plate glass being in contact with air, a reflection preventing treatment was performed with 5 layers of dielectric substances by vacuum vapor deposition.

The same light resistance evaluation as in Example 5 was performed, to find a phenomenon that the initial evaluation was excellent, however, in the case of being left under environments of a temperature of 60° C. and a relative humidity of 90% for hours, deterioration of the polarizer progressed rapidly. The results are summarized in Table 2.

TABLE 2

| | Protective | | | Evaluation of light | |
|---|---|---|---|---|---|
| | film | | Constitution | resistance | |
| | one | | of | Initial | |
| | surface/other | Drying | polarizing | period | Long |
| | surface | conditions | sheet | (h) | period |
| Examples | | | | | |
| 5 | 80 μm, TAC/80 μm, | 70° C. × 180 min. | FIG. 1 | 65 | ∘ |
| | TAC | | | | |
| 6 | 80 μm, TAC/40 μm, | 80° C. × 120 min. | FIG. 3 | 72 | ∘ |
| | Zeonor | | | | |
| 7 | 40 μm, | 80° C. × 120 min. | FIG. 5 | 95 | ∘ |
| | TAC/none | | | | |
| Comparative | | | | | |
| Examples | | | | | |
| 3 | 80 μm, TAC/80 μm, | none | FIG. 6 | 12 | un- |
| | TAC | | | | measurable |
| 4 | 80 μm, TAC/80 μm, | 80° C. × 120 min. | FIG. 6 | 60 | x |
| | TAC | | | | |

### Example 8

Onto one surface of a polarizing film obtained in the same manner as in Example 5, sapphire glass (manufactured by Kyocera Corporation) having a thickness of 0.5 mm was pasted via an adhesive, and dried in an oven of 80° C. for 120 minutes, then, onto the other one side was pasted blue plate glass of 0.1 mm, and the water content of the polarizing film was controlled to 1.2 wt % or less. Subsequently, immediately, a sealing material (epoxy-based thermosetting resin, manufactured by CEMEDINE Co. Ltd., EP582, viscosity: 280 cP, water vapor transmission rate: 20 g/m²·24 hr) was dropped in an amount of 0.01 ml using a syringe having a needle point outer diameter of 0.6 mm from 4 positions at side surfaces of the polarizing sheet as shown in FIG. 24, and four sides as exposed portions of the polarizing film were sealed completely over 15 seconds per position. Further, the sheet was heated at 120° C. for 2 hours to cause hardening of the sealing material, to obtain a polarizing sheet of the present invention. The hardened substance (hardened sealing material) at this stage had a glass transition temperature of 125° C.

Thus obtained polarizing sheet was placed in a light path for a blue channel of a light resistance evaluation apparatus shown in FIG. 26, and time until generation of light leakage due to deterioration was checked to find a result of 55 hours.

The light resistance evaluation apparatus used in this procedure used a 100 W high pressure mercury lamp manufactured by Phillips as a light source, and evaluation was performed in the same manner as in Example 5 excepting that the irradiation light quantity onto a polarizing sheet such as a polarizing beam splitter array and the like was 2.5 W per 1 cm².

### Example 9

The same procedure as in Example 8 was carried out excepting that blue plate glass having hole parts having a diameter of 1 mm at four corners and having a thickness of 1 mm illustrated in FIG. 21 was used as the blue plate glass, to obtain a polarizing sheet of the present invention. When a sealing material was poured through the hole parts, four sides as exposed portions of the polarizing film could be completely sealed in 7 seconds per position.

The light resistance evaluation results were equivalent to those of Example 8.

### Example 10

Onto one surface of a polarizing film obtained in the same manner as in Example 5, sapphire glass (manufactured by Kyocera Corporation) having a thickness of 0.5 mm was pasted via an adhesive, and dried in an oven of 80° C. for 120 minutes, then, onto the other one side was pasted blue plate glass of 0.1 mm, and the water content of the polarizing film was controlled to 1.2 wt % or less. Subsequently, immediately, a silicone-based ultraviolet ray-hardening resin (FX-V550 manufactured by ADEKA, viscosity: 5 Pa·s, water vapor transmission rate: 30 g/m²·24 hr) as a sealing material was dropped in an amount of 0.01 ml using a syringe having a needle point outer diameter of 0.6 mm from 4 positions of concave defective parts using the transparent substrate shown in FIG. 23, and four sides as exposed portions of the polarizing film were sealed completely over 60 seconds per position. Further, the sheet was irradiated with light of 1 J/cm² by a high pressure mercury lamp, to cause hardening of the sealing material, obtaining a polarizing sheet of the present invention. The hardened substance (hardened sealing material) at this stage had a glass transition temperature of 200° C.

The same light resistance evaluation as in Example 8 was carried and time until generation of light leakage due to deterioration was checked to find a result of 60 hours.

### Example 11

Onto one surface of a polarizing film obtained in the same manner as in Example 5, sapphire glass (manufactured by Kyocera Corporation) having a thickness of 0.5 mm was pasted via an adhesive, and dried in an oven of 80° C. for 120 minutes, then, immediately, onto the other one side was pasted blue plate glass of 0.1 mm, and the water content of the polarizing film was controlled to 1.2 wt % or less. Subsequently, immediately, an epoxy-based ultraviolet ray-hardening resin (KR695A manufactured by ADEKA, viscosity: 0.45 Pa·s, water vapor transmission rate: 50 g/m²·24 hr) as a sealing material was dropped in an amount of 0.01 ml using a syringe having a needle point outer diameter of 0.6 mm from 4 positions of concave defective parts using the transparent substrate shown in FIG. 23, and four sides as exposed portions of the polarizing film were sealed completely over 20 seconds per position. Further, the sheet was irradiated with light of 3.6 J/cm² by a high pressure mercury lamp, to cause hardening of the sealing material, obtaining a polarizing sheet of the present invention.

The same light resistance evaluation as in Example 8 was carried and time until generation of light leakage due to deterioration was checked to find a result of 65 hours.

### Example 12

A polyvinyl alcohol film (VF-PX manufactured by Kuraray Co., Ltd., hereinafter referred to as PVA) was stretched uni-axially, dyed with a red dye, and dried to obtain a polarizer for projector blue channel showing a degree of polarization of 99.9% and a transmittance of 44.0% at a thickness of 28 μm and a wavelength of 440 nm. Onto one surface of this polarizer (PVA), an acetyl cellulose-based film (KC8UY manufactured by Konica Corp., hereinafter referred to as 8UYTAC) having a thickness of 80 μm was pasted as a protective film with an adhesive containing a water-soluble polyamide epoxy resin (product name: Sumirez Resin 650) as an active ingredient in a carboxyl group-modified polyvinyl alcohol resin (product name: KL318), to produce a polarizing film. Onto one surface of the resultant polarizing film, sapphire glass (manufactured by Kyocera Corporation) having a thickness of 0.5 mm was pasted via an adhesive, and dried in an oven of 110° C. for 120 minutes while maintaining this configuration, to control the water content of the polarizing film to 1.2 wt % or less. After drying, onto the other polarizer surface, blue plate glass of 0.1 mm was pasted. Thereafter, an ultraviolet ray-hardening resin was applied so as to cover the section and exposed portions of the polarizing sheet, and hardened to obtain a polarizing sheet having the same constitution as that of the schematic view of FIG. 15. On surfaces of both the sapphire glass and blue plate glass used being in contact with air, a reflection preventing treatment was performed with 5 layers of dielectric substances by vacuum vapor deposition.

Thus obtained polarizing sheet was placed in a light path for a blue channel of a light resistance evaluation apparatus shown in FIG. 26, and time until generation of light leakage due to deterioration was checked to find a result of 65 hours. Further, the resultant sample was left under environments of a temperature of 60° C. and a relative humidity of 90% for 72 hours, thereafter, light resistance thereof was evaluated in an analogous manner, to find no deterioration of light resistance.

This polarizing sheet was applied to the incident side and outgoing side of a liquid crystal element of a liquid crystal projector optical system, to obtain a screen of extremely excellent contrast. In this procedure, the polarizing sheet was so placed that the surface of the blue plate glass faced the liquid crystal element both at the incident side and outgoing side.

### Example 13

Onto one surface of the polarizer (PVA) obtained in the same manner as in Example 12, an acetyl cellulose-based film (KC4UY manufactured by Konica Corp., hereinafter referred to as 4UYTAC) having a thickness of 40 μm was pasted with an epoxy-based adhesive, to produce a polarizing film. Onto the protective film side of the resultant polarizing film, sapphire glass (manufactured by Kyocera Corporation) having a thickness of 0.5 mm was pasted via an adhesive, and dried in an oven of 120° C. for 1 hour, to control the water content of the polarizing film to 1.2 wt % or less. Next, onto the polarizer side, blue plate glass of 0.1 mm was pasted. Further, the section of the polarizing film was covered with an UV-hardening resin, to obtain a polarizing sheet having a constitution shown in FIG. 17. On surfaces of both the sapphire glass and blue plate glass being in contact with air, a reflection preventing treatment was performed with 5 layers of dielectric substances by vacuum vapor deposition.

The same light resistance evaluation as in Example 12 was performed, to resultantly find excellent initial evaluation and no deterioration even in long period evaluation. Contrast thereof was observed in the same manner as in Example 1, to obtain an excellent screen. The results are summarized in Table 3 together with Example 12.

### Example 14

Onto only one surface of the same polarizer (PVA) as in Example 1, an olefin resin film (Zeonor: registered trade mark, manufactured by ZEON Corporation, thickness 40 μm) was pasted with an epoxy-based adhesive, to produce a polarizing film. Onto the protective film side of the resultant polarizing sheet, sapphire glass (manufactured by Kyocera Corporation) having a thickness of 0.5 mm was pasted via an adhesive, and dried in an oven of 130° C. for 1 hour, to control the water content of the polarizing film to 1.2 wt % or less. Next, onto the polarizer side, blue plate glass of 0.1 mm was pasted. Further, the section of the polarizing sheet was covered with an VU-hardening resin, to obtain a polarizing sheet having a constitution shown in FIG. 17. On surfaces of both the sapphire glass and blue plate glass being in contact with air, a reflection preventing treatment was performed with 5 layers of dielectric substances by vacuum vapor deposition.

The same light resistance evaluation as in Example 12 was performed, to resultantly find excellent initial evaluation and no deterioration even in long period evaluation. Contrast thereof was observed in the same manner as in Example 12, to obtain an excellent screen. The results are summarized in Table 3 together with Example 12.

### Comparative Example 5

Onto the polarizer side of a polarizing film obtained in the same manner as in Example 12, sapphire glass (manufactured by Kyocera Corporation) having a thickness of 0.5 mm was pasted via an adhesive, and through no drying process, onto the other protective film side was pasted blue plate glass of 0.1 mm, to obtain a polarizing sheet having a constitution shown in FIG. 19. It had at this stage a constitution in which the section the polarizing sheet and parts of the surface of the polarizing film not covered with blue plate glass were in contact with air. On surfaces of both the sapphire glass and blue plate glass being in contact with air, a reflection preventing treatment was performed with 5 layers of dielectric substances by vacuum vapor deposition. This polarizing sheet was applied to the incident side and outgoing side of a liquid crystal element of a liquid crystal projector optical system, to obtain no screen of excellent contrast. In this procedure, the polarizing sheet was so placed that the surface of the blue plate glass faced the liquid crystal element both at the incident side and outgoing side.

Thus obtained polarizing sheet was subjected to the same light resistance evaluation as in Example 1, to find that light leakage due to deterioration of the polarizer occurred in only 12 hours in the stage of the initial evaluation, further, in the case of being left under environments of a temperature of 60° C. and a relative humidity of 90% for 72 hours, deterioration progressed rapidly and correct data could not be obtained. The results are summarized in Table 3.

### Comparative Example 6

Onto the polarizer side of a polarizing film obtained in the same manner as in Example 12, sapphire glass (manufactured by Kyocera Corporation) having a thickness of 0.5 mm was pasted via an adhesive, and dried in an oven of 110° C. for 120 minutes while maintaining this configuration, to control the water content of the polarizing film to 1.2 wt % or less. Next, onto the protective film side, blue plate glass of 0.1 mm was pasted, to obtain a polarizing sheet having as constitution shown in FIG. 20. It had at this stage a constitution in which the section the polarizing sheet was in contact with air. On surfaces of both the sapphire glass and blue plate glass being in contact with air, a reflection preventing treatment was performed with 5 layers of dielectric substances by vacuum vapor deposition.

This polarizing sheet was applied to the incident side and outgoing side of a liquid crystal element of a liquid crystal projector optical system, to obtain no screen of excellent contrast. In this procedure, the polarizing sheet was so placed that the surface of the blue plate glass faced the liquid crystal element both at the incident side and outgoing side.

Thus obtained polarizing sheet was subjected to the same light resistance evaluation as in Example 12, to find that light leakage due to deterioration of the polarizer occurred in only 12 hours in the stage of the initial evaluation, further, in the case of being left under environments of a temperature of 60° C. and a relative humidity of 90% for 72 hours, deterioration progressed rapidly and correct data could not be obtained. The results are summarized in Table 3.

TABLE 3

| | Constitution | | | | | |
|---|---|---|---|---|---|---|
| | | Transparent | | | | Light |
| | | substrate | | | | resistance |
| | | at | | | | Initial |
| | Protective | polarizer | Drying | | | (h)/long |
| | film | side | condition | Constitution | Contrast | period |
| Examples | | | | | | |
| 12 | 80 μm, | Blue | 110° C. × 120 min | FIG. 15 | ∘ | 65/∘ |
| | TAC | plate | | | | |
| | | glass | | | | |
| 13 | 40 μm, | Blue | 120° C. × 60 min | FIG. 17 | ∘ | 95/∘ |
| | TAC | plate | | | | |
| | | glass | | | | |
| 14 | 40 μm, | Blue | 130° C. × 60 min | FIG. 17 | ∘ | 72/∘ |
| | Zeonor | plate | | | | |
| | | glass | | | | |
| Comparative | | | | | | |
| Examples | | | | | | |
| 5 | 80 μm, | Sapphire | none | FIG. 19 | x | 12/un-measurable |
| | TAC | | | | | |
| 6 | 80 μm, | Sapphire | 110° C. × 120 min | FIG. 20 | x | 66/x |
| | TAC | | | | | |

The polarizing sheet of the present invention can maintain optical properties even in the case of strong irradiation with light from a light source, and, when applied to a polarizing sheet of a projection type liquid crystal display such as a front projector, rear projector and the like, is capable of contributing significantly to elongation of the life of the apparatus, thus manifesting excellent practical utility.

What is claimed is:

1. A polarizing sheet having a transparent substrate on both surfaces of a polarizing film containing a polarizer, wherein exposed portions of the polarizing film not covered by the transparent substrate are covered with a sealing material.

2. The polarizing sheet according to claim 1, wherein the water content of the polarizer is 5 wt % or less.

3. The polarizing sheet according to claim 1, wherein the sealing material is an ultraviolet ray-hardening adhesive or a thermosetting adhesive.

4. The polarizing sheet according to claim 3, wherein the sealing material has a glass transition temperature after hardening of 80° C. or higher.

5. The polarizing sheet according to claim 3, wherein the sealing material has a viscosity at 25° C. before hardening of 10 Pa·s or less.

6. The polarizing sheet according to claim 1, wherein the sealing material has a boiling water absorption coefficient after hardening of 4 wt % or less.

7. The polarizing sheet according to claim 1, wherein the sealing material has a boiling water absorption coefficient after hardening of 2 wt % or less.

8. The polarizing sheet according to claim 1, wherein at least one of the transparent substrates is made of a material having a thermal conductivity coefficient of 5 W/mK or more.

9. The polarizing sheet according to claim 1, wherein resin layers are formed between the transparent substrate made of a material having a thermal conductivity coefficient of 5 W/mK or more and the polarizer, and the total thickness of the resin layers is 0.1 μm or more and less than 10 μm.

10. The polarizing sheet according to claim 9, wherein the material of one of the transparent substrates is quartz crystal or sapphire, and the material of the other substrate is quartz crystal, quartz glass, silicate glass or borosilicate glass.

11. The polarizing sheet according to claim 1, wherein the polarizing film is a polarizing film containing a polarizer and a protective film.

12. The polarizing sheet according to claim 11, wherein the polarizing film has a water content of 1.6 wt % or less.

13. The polarizing sheet according to claim 11, wherein the protective film has a thickness of 10 to 45 μm.

14. The polarizing sheet according to claim 11, wherein the protective film is a film containing triacetylcellulose or an olefin resin film.

15. The polarizing sheet according to claim 11, wherein at least one of the transparent substrates is made of a material having a thermal conductivity coefficient of 5 W/mK or more.

16. The polarizing sheet according to claim 11, wherein resin layers are formed between the transparent substrate made of a material having a thermal conductivity coefficient of 5 W/mK or more and the polarizer, and the total thickness of the resin layers is 0.1 μm or more and less than 10 μm.

17. The polarizing sheet according to claim 16, wherein the material of one of the transparent substrates is quartz crystal or sapphire, and the material of the other substrate is quartz crystal, quartz glass, silicate glass or borosilicate glass.

18. The polarizing sheet according to claim 11, wherein the polarizing film is composed of one polarizer and one protective film, a transparent substrate is pasted to both surfaces of the polarizing film, and the transparent substrate pasted to the polarizer is a transparent substrate made of a material having no optical anisotropy.

19. The polarizing sheet according to claim 18, wherein the transparent substrate having no optical anisotropy is made of silicate glass or borosilicate glass.

20. The polarizing sheet according to claim 1, wherein the sheet has a lamination part having a thickness of 1 μm or more and 30 μm or less between the polarizer and at least one of the transparent substrates, the lamination part is composed of two or more resin layers formed from a thermosetting resin or an ultraviolet-hardening resin, and the lamination part contains an adhesive layer.

21. The polarizing sheet according to claim 20, wherein the content of volatile components of the resin layers formed in the polarizing sheet before hardening is 2 wt % or less.

22. The polarizing sheet according to claim 20, wherein the viscosity of the resin layer formed in the polarizing sheet before hardening is 0.01 Pa·s or more and 20 Pa·s or less at 25° C.

23. The polarizing sheet according to claim 20, wherein when the resin layer formed in the polarizing sheet has a thickness after hardening of 25 μm, light transmittance is 90% or more in the wavelength range of 400 nm to 700 nm.

24. A method for producing a polarizing sheet having a transparent substrate on both surfaces of a polarizing film containing a polarizer and in which exposed portions of the polarizing film not covered with the transparent substrate are covered with a sealing material, wherein the transparent substrate is adhered using a resin to both surfaces of the polarizing film, the polarizing film is dried, thereafter, exposed portions of the polarizing film not covered with the transparent substrate are covered with a sealing material.

25. The method for producing a polarizing sheet according to claim 24, wherein, in adhering the transparent substrate using a resin to the polarizing film, at least one of a process for forming a resin layer before hardening the resin to be used as an adhesive layer and a process for setting an article to be adhered is carried out under reduced pressure.

26. The method for producing a polarizing sheet according to claim 24, wherein the method contains a process of drying the polarizing film at temperatures of 110° C. or lower, before adhering the second transparent substrate to the polarizing film.

27. The method for producing a polarizing sheet according to claim 24, wherein at least one of the transparent substrates has a concave defective part and/or hole part for sealing material injection, and the method contains a process for injecting a sealing material through the concave defective part and/or hole part.

28. A projection type liquid crystal display having the polarizing sheet according to claim 1.

29. The polarizing sheet according to claim 1, wherein when the resin covering exposed portions of the polarizer has a film thickness after hardening of 100 μm, the water vapor transmission rate under environments of a temperature of 40° C. and a relative humidity of 90% is 60 g/m²·24 hr or less.

30. The polarizing sheet according to claim 1, wherein when the resin covering exposed portions of the polarizer has a film thickness after hardening of 100 μm, the water vapor transmission rate under environments of a temperature of 40° C. and a relative humidity of 90% is 25 g/m²·24 hr or less.
